(19) United States
(12) Patent Application Publication
(10) Pub. No.: US 2002/0168086 A1
(43) Pub. Date: Nov. 14, 2002

(54) Encoding, producing and decoding methods of object data, and apparatuses for encoding, producing and decoding the object data, and programs for encoding and decoding the object data, and recording medium for the object data

(76) Inventor: Takayuki Sugahara, Yokosuka-shi (JP)

Correspondence Address: Morris Liss, Connolly Bove Lodge & Hutz LLP, Suite 800, 1990 M Street, N.W., Washington, DC, 20036-3425, US

(21) Appl. No.: 10/124,768

(22) Filed: Apr. 18, 2002

(30) Foreign Application Priority Data
Apr. 18, 2001 (JP) 2001-119355
Feb. 26, 2002 (JP) 2002-049416

(51) Int. Cl. G06K 9/00

(52) U.S. Cl. 382/100

(57) ABSTRACT

When reproducing contents, which are encoded by an MPEG compressor (12) in accordance with each of a plurality of objects and recorded in a recording medium (20), a reproduction protection information based on a region or rating for each of contents is produced by a reproduction protection information generator (13). The reproduction protection information is inserted into an object signal by a control header inserter (14) or an electronic watermark inserter (16) and recorded. When reproducing the object signal, synthesizing a certain object signal, which is prohibited to reproduce by a reproduction protection information, is restricted by a reproduction protection controller (34), and then a video signal, which is permitted to reproduce is produced.

### BACKGROUND OF THE INVENTION

1. Field of the Invention

The present invention relates to encoding, producing and decoding methods of an object data, and apparatuses for encoding, producing and decoding the object data, and programs for encoding and decoding the object data, and a recording medium for the object data, particularly, relates to an electronic watermark, which is conducted by mixing an information related to copyright with another information such as audio, picture, video and multimedia data, in order to verify the right of ownership of a copyright holder and to identify infringement of copyright and to transmit a hidden massage. In particular, the present invention relates to encoding and decoding an object data, which can be managed by a region management for controlling an object data enabling to be reproduced and a parental lock control, and a recording medium for the object data.

2. Description of the Related Art

A video tape recorder (VTR) using a tape has been used for recording a video signal or like until now. Recently, however, a hard disc drive (HDD) having a capability of random access has been popularized and a recording capacity of DVD-RAM (Digital Versatile Disc-Random Access Memory) disc has been increased. Consequently, a disc recorder using a disciform recording medium such as a hard disc and a DVD-RAM disc has been coming into practice.

The disc recorder records content data, which are obtained by encoding data by an encoding method such as the MPEG (Moving Picture Experts Group) Standard, in a disciform recording medium and reproduces the content data. Further, the disc recorder has a feature such that it can perform a plurality of actions simultaneously while recording and reproducing such a recording medium excellent in an ability of random access. Furthermore, the disc recorder has been used as a recording and reproducing apparatus of an object data, which could record a video signal to be recorded by dividing the video signal into a plurality of objects and display the video signal obtained by synthesizing the plurality of objects on a screen for display.

Moreover, the object data are data in digital. In a case of digital recording and reproducing the object data, deterioration of quality in accordance with recording and reproducing or transmitting an information signal never happens in comparison with recording and reproducing an analog signal, so that a copyright holder of a picture or object data has proposed a subject concerning a protection of the copyright.

With respect to such a protection of the copyright of content data, by using a technique that an electronic watermark signal, for example, is embedded in a digital picture or a content signal such as a digital audio signal with keeping a quality of the content signal not to be deteriorated and concealed, the embedded watermark signal is separated from the content signal through a predetermined signal processing method and can be extracted as the copyright information concerning contents of the content signal.

With respect to a method of embedding the electronic watermark, there is provided various proposals. For example, NTT (Nippon Telegraph and Telephone Corporation) announced “The Embedding Method of Copyright Information in Digital Moving Picture by the DCT Method” at the SCIS' 97 (The 1997 Symposium on Cryptography and Information Security)-31G.

In the Symposium, NTT proposed the embedding method of an information based upon, particularly, alteration of a DCT (Discrete Cosine Transform) modulus, a motion vector and a quantization characteristic.

Further, the Defense Academy announced “The Method of Autographing Watermark on Picture by the PN Succession” at the SCIS'97-26B. The method follows the direct spreading method. A picture signal is spread by the PN (Pseudo Noise) succession. The Defense Academy proposed the method of synthesizing an autograph information with the picture signal.

On the other hand, by recording a protection information concerning reproduction of medium and assigning the protection information to a reproducing apparatus, a reproduction controlling method that a final reproduction protection level is decided by a combination of recording and reproducing systems is disclosed in the Japanese Patent Application Laid-open Publication No. 7-235131/1995 entitled “Reproduction Protection Method and Protection Reproducing Apparatus”.

As mentioned above, an information related to possession of the copyright of a content information being produced can be embedded in the content information by the above-mentioned method and is used for protecting a copyrighted work. It is supposed to be able to send out a warning to illegal use of the content information.

However, by the conventional method mentioned above, contents recorded in a medium constitute one program, so that the program can not be reproduced totally by a protection controlling information or it is possible to control such that the program is not reproduced for a certain period of time. Reproduction control by eliminating each constituting element of the contents or reproduction by switching one constituting element to another constituting element of the contents such as a specific object constituting the program, for example, a specific person or a specific background in a reproduced picture on a screen could not be performed. Further, in the case of a reproduced audio signal, reproduction control by eliminating each constituting element of the contents or reproduction by switching one constituting element to another constituting element of the contents such as a specific object constituting the program, for example, a voice uttered by a specific person or a BGM (Back Ground Music) played by a specific musician could not be performed either.

### SUMMARY OF THE INVENTION

Accordingly, in consideration of the above-mentioned problems of the prior arts, an object of the present invention is to provide encoding, signal producing and decoding methods of an object data, and apparatuses for encoding, producing and decoding the object data, and programs for encoding and decoding the object data, and a method for realizing a recording medium for the object data, wherein the object data can protect reproduction of contents in accordance with locality of the contents or restricting an age of audience, and is high in security level and hard to be reproduced illegally by alteration, by applying a reproduction control for displaying and pronouncing to objects constituting contents to be recorded in or transmitted by a medium, or synthesizing the objects by switching one object to another object, and further recording and reproducing the objects by embedding a reproduction control signal to be recorded in each object as an electronic watermark.

In order to achieve the above object, the present invention provides, according to a first aspect thereof, an encoding method of object data comprising steps of: producing a reproduction protection information signal so as to permit reproduction of a plurality of object data constituting contents; compression-encoding each of the plurality of object data and resulted in a compression-encoded signal of each object; and multiplexing the reproduction protection information signal and the compression-encoded signal and producing a multiplexed signal.

According to a second aspect of the present invention, there provided a producing method of object data comprising steps of: producing a reproduction protection information signal so as to permit reproduction of a plurality of object data constituting contents; compression-encoding each of the plurality of object data and resulted in a compression-encoded signal of each object; multiplexing the reproduction protection information signal and the compression-encoded signal and producing a multiplexed signal thereby; and producing a packetized multiplexed signal by packetizing the multiplexed signal produced in the step of multiplexing by every predetermined amount of data.

According to a third aspect of the present invention, there provided a decoding method of object data for decoding a multiplexed signal produced by multiplexing a reproduction protection information signal for permitting reproduction of a plurality of object data constituting contents and a compression-encoded signal of each object obtained by compression-encoding each of the plurality of object data, the decoding method comprising steps of: separating the multiplexed signal into the compression-encoded signal and the reproduction protection information signal; and synthesizing the plurality of object data permitted to reproduce by the reproduction protection information signal and obtaining a synthesized object signal thereby, wherein the plurality of object data is obtained by decoding the compression-encoded signal.

According to a fourth aspect of the present invention, there provided an apparatus for encoding object data comprising: compression-encoding means for compression-encoding each of a plurality of object data constituting contents and for obtaining a compression-encoded signal of each object thereby; reproduction protection information signal producing means for producing a reproduction protection information signal so as to permit reproduction of the plurality of object data; and multiplexed signal producing means for multiplexing the reproduction protection information signal produced by the reproduction protection information signal producing means and the compression-encoded signal obtained by the compression-encoding means and for obtaining a multiplexed signal thereby.

According to a fifth aspect of the present invention, there provided an apparatus for producing object data comprising: reproduction protection information signal producing means for producing a reproduction protection information signal so as to permit reproduction of a plurality of object data constituting contents; multiplexed signal producing means for multiplexing the reproduction protection information signal produced by the reproduction protection information signal producing means and a compression-encoded signal obtained by compression-encoding each of the plurality of object data and for obtaining a multiplexed signal thereby; and packetized data producing means for packetizing the multiplexed signal by every predetermined amount of data and for producing a packetized multiplexed signal thereby.

According to a sixth aspect of the present invention, there provided an apparatus for decoding object data, wherein the apparatus decodes a multiplexed signal produced by multiplexing a reproduction protection information signal for permitting reproduction of a plurality of object data constituting contents and each compression-encoded signal of each object obtained by compression-encoding each of the plurality of object data, the apparatus comprising: signal separating means for separating the multiplexed signal into the compression-encoded signal and the reproduction protection information signal; and signal synthesizing means for synthesizing the plurality of object data permitted to reproduce by the reproduction protection information signal and for obtaining a synthesized object signal thereby, wherein the plurality of object data is obtained by decoding the compression-encoded signal.

According to a seventh aspect of the present invention, there provided a program for encoding object data by executing a computer comprising steps of: producing a reproduction protection information signal for permitting reproduction of a plurality of object data constituting contents in accordance with a region information and a rating information; and producing a multiplexed signal by multiplexing each compression-encoded signal of each object obtained by compression-encoding each of the plurality of object data.

According to an eighth aspect of the present invention, there provided a program for decoding object data, wherein the program decodes a multiplexed signal produced by multiplexing a reproduction protection information signal related to a region information and a rating information so as to permit reproduction of a plurality of object data constituting contents and each compression-encoded signal of each object obtained by compression-encoding each of the plurality of object data by executing a computer, the program comprising steps of: separating the multiplexed signal into the compression-encoded signal and the reproduction protection information signal; and synthesizing the plurality of object data permitted to reproduce by the reproduction protection information signal and obtaining a synthesized object signal thereby, wherein the plurality of object data is obtained by decoding the compression-encoded signal.

According to a ninth aspect of the present invention, there provided a recording medium for object data characterized in that the recording medium is recorded with a multiplexed signal obtained by multiplexing: a reproduction protection information signal produced so as to permit reproduction of a plurality of object data constituting contents in accordance with a region information and a rating information; and a compression-encoded signal of each object obtained by compression-encoding each of the plurality of object data.

Other object and further features of the present invention will be apparent from the following detailed description when read in conjunction with the accompanying drawing.

### BRIEF DESCRIPTION OF DRAWINGS

FIG. 1 is a block diagram of a recording and reproducing system for object data according to an embodiment of the present invention.

FIG. 2 is an example of a picture displayed on a screen for explaining an object recording according to the embodiment of the present invention.

FIG. 3 is another example of a picture displayed on a screen for explaining an object recording according to the embodiment of the present invention.

FIG. 4 is a block diagram of a first apparatus for encoding object data according to the embodiment of the present invention.

FIG. 5 is a block diagram of a first apparatus for decoding object data according to the embodiment of the present invention.

FIG. 6 is a block diagram of a second apparatus for encoding object data according to the embodiment of the present invention.

FIG. 7 is a block diagram of a second apparatus for decoding object data according to the embodiment of the present invention.

FIG. 8 shows a data format of reproduction protection information transmitted through a control header according to the embodiment of the present invention.

FIG. 9 shows a data format of reproduction protection information transmitted by the electronic watermarking method according to the embodiment of the present invention.

FIG. 10 shows an exemplary region code in five types according to the embodiment of the present invention.

FIG. 11 is an exemplary chart showing a relationship between a rating information and a reproduction whether it is permitted or not according to the embodiment of the present invention.

FIG. 12 is an exemplary chart showing a relationship between an object and a region code according to the embodiment of the present invention.

FIG. 13 shows a reproduction program of objects 1 through 4 during a time period from a time “t1” to another time “t2” shown in FIG. 12.

FIG. 14 is an exemplary chart showing a relationship between an object and a rating code according to the embodiment of the present invention.

FIG. 15 shows a reproduction program of objects 1 through 4 during a time period from a time “t1” to another time “t2” shown in FIG. 14.

FIG. 15 is another exemplary chart showing a relationship between an object and a rating code according to the embodiment of the present invention.

FIG. 16 is a block diagram of an apparatus for producing an encoded object data signal, which produces an encoded signal using a control header for transmission according to the embodiment of the present invention.

FIG. 17 shows a data configuration formed in a plurality of packets according to the embodiment of the present invention.

FIG. 18 is a block diagram of a first receiving apparatus of object data according to the embodiment of the present invention.

FIG. 19 is a block diagram of a first transmitting apparatus of object data according to the embodiment of the present invention.

FIG. 20 is a block diagram of a second receiving apparatus of object data according to the embodiment of the present invention.

FIG. 21 is a first flow chart showing a program of encoding process of object data by inserting a control header into the object data according to the embodiment of the present invention.

FIG. 22 is a second flow chart showing a program of decoding process for reproducing object data, which are recorded or transmitted with being added with a control header according to the embodiment of the present invention.

FIG. 23 is a third flow chart showing a program of decoding process and transmitting process of object data according to the embodiment of the present invention.

FIG. 24 is a fourth flow chart showing a program of decoding process of object data for reproducing the object data, which are recorded in a recording medium or transmitted with adding a control signal by the electronic watermarking method according to the embodiment of the present invention.

FIG. 25 is a block diagram of a third apparatus for encoding object data according to the embodiment of the present invention.

FIG. 26 is a block diagram of a third apparatus for decoding object data according to the embodiment of the present invention.

FIG. 27 is a block diagram of a second transmitting apparatus of object data according to the embodiment of the present invention.

FIG. 28 is a block diagram of a third receiving apparatus of object data according to the embodiment of the present invention.

FIG. 29 is a fifth flow chart showing a program of encoding process of object data, which performs reproduction control for a predetermined group of objects, by inserting a control header into the object data according to the embodiment of the present invention.

FIG. 30 is a sixth flow chart showing a program of decoding process of object data in order to reproduce object data containing a group of objects, which is recorded or transmitted with being affixed with a control header according to the embodiment of the present invention.

### DETAILED DESCRIPTION OF THE PREFERRED EMBODIMENTS

[Embodiment]

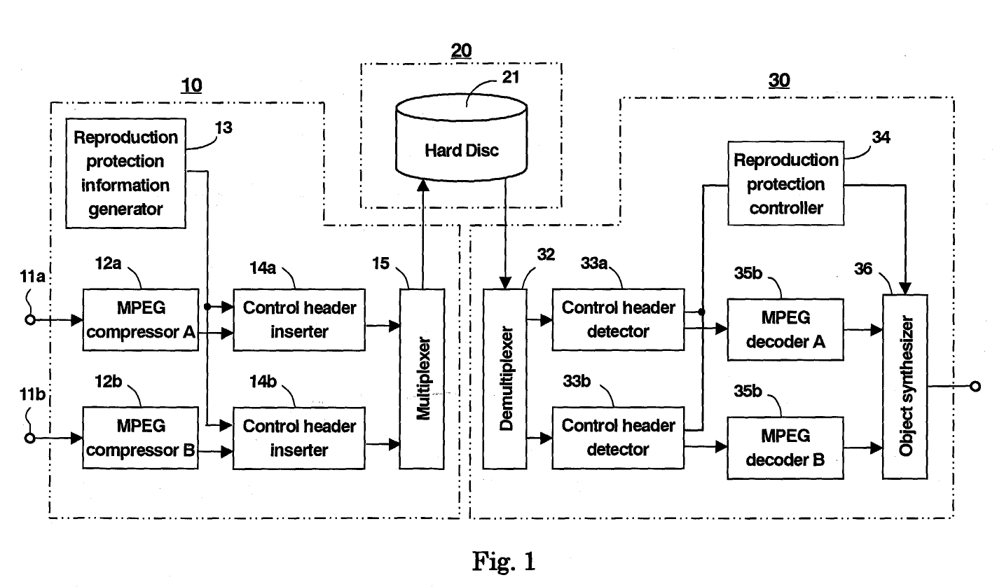

FIG. 1 is a block diagram of a recording and reproducing system for object data according to an embodiment of the present invention.

In FIG. 1, a recording and reproducing system is composed of an apparatus 10 for encoding object data, a recording apparatus 20 including a hard disc 21 for the object data and another apparatus 30 for decoding the object data. The apparatus 10 for encoding object data is further composed of an MPEG compressor A 12a, another MPEG compressor B 12b (hereinafter referred to as MPEG compressors 12a and 12b), a reproduction protection information generator 13, a control header inserter 14a, another control header inserter 14b, a multiplexer 15 and two input terminals 11a and 1b. The other apparatus 30 for decoding the object data is further composed of a demultiplexer 32, two control header detectors 33a and 33b, a reproduction protection controller 34, an MPEG decoder A 35a, another MPEG decoder B 35b (hereinafter referred to as MPEG decoders 35a and 35b), an object synthesizer 36 and an output terminal 31.

Operations of the recording and reproducing system are detailed next.

Each signal of an object data A and another object data B to be encoded and recorded is supplied to the MPEG compressors 12a and 12b through the input terminals 11a and 11b respectively.

In each of the MPEG compressors 12a and 12b, the object data A and the other object data B are encoded by the MPEG-4 Standard, wherein the object data A and the other object data B are, for example, a body A and another body B composing a picture. These bodies A and B are compressed and encoded by respective MPEG-4 compressors in the MPEG compressors 12a and 12b independently.

Each of the object data A and B encoded as mentioned above is supplied to the control header inserters 14a and 14b respectively. At the same time, a reproduction permitting information signal or a reproduction protection information signal, which is generated by the reproduction protection information generator 13, is also supplied to the control header inserters 14a and 14b respectively.

The reproduction protection information signal is a signal such as a so-called region code for permitting a reproduction of contents classified by a country or state. In some cases, the signal is a so-called rating code, which is a kind of code related to restricting to an age of audience for the contents.

In the control header inserters 14a and 14b supplied with the above-mentioned signals, a header signal containing an information concerning a region code and a rating code is added to the head of respective object data A and B, which are compressed and encoded. Each of the compression-encoded signals of which object data A and B are headed by the control header is supplied to the multiplexer 15.

In the multiplexer 15, the compression-encoded signals supplied in parallel are multiplexed and produced as a serial signal. The produced serial signal is supplied to the recording apparatus 20 and recorded in the hard disc 21 as an encoded signal.

The encoded signal recorded in the hard disc 21 is read out by a reading out device, not shown, for the hard disc 21. The encoded signal read out is supplied to the demultiplexer 32.

In the demultiplexer 32, the encoded signal supplied as a serial signal format is demultiplexed and separated into two signals related to respective object data A and B. One signal related to the object data A and the other signal related to the object data B are supplied to the control header detectors 33a and 33b respectively.

In the control header detectors 33a and 33b, a header signal added to the respective object data A and B is detected.

Each header information of the header signal detected as mentioned above is supplied to the reproduction protection controller 34. Each of compression-encoded signals related to the object data A and B is supplied to the MPEG decoders 35a and 35b respectively, wherein the control headers are removed from the compression-encoded signals by the control header detectors 33a and 33b.

In the MPEG decoders 35a and 35b, each signal of the encoded object data A and B is decoded and supplied to the object synthesizer 36.

In the object synthesizer 36, by a reproduction control signal supplied from the reproduction protection controller 34, a signal of object permitted to be reproduced out of the object data A and B is synthesized and outputted to the output terminal as a video signal output. The video signal is supplied to a monitor TV, not shown, connected to the output terminal and displayed on the screen of the monitor TV.

As mentioned above, the object data A and B supplied to the input terminals 11a and 11b are encoded by the MPEG-4 System and recorded by the recording apparatus 20 with adding the reproduction protection information related to the objects A and B.

The recorded object data is reproduced and a object data signal permitted to be reproduced in accordance with the reproduction protection information for the objects is synthesized and outputted as a video signal from the recording and reproducing system for the object data.

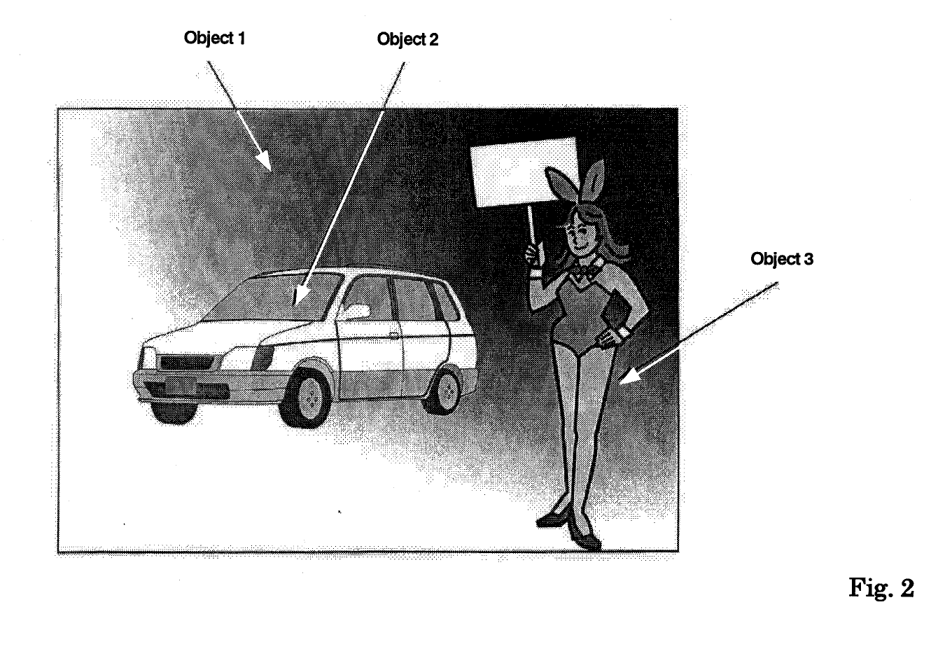

With referring to FIG. 2, a configuration of object data and operations related to reproduction permission are detailed next.

FIG. 2 is an example of a picture displayed on a screen for explaining; an object recording according to the embodiment of the present invention.

In FIG. 2, the picture displayed on a screen is composed of a background as an object 1, an automobile as an object 2 and a bunny girl as an object 3. The picture shown in FIG. 2 is displayed after a reproduction of each of the objects 1 through 3 is permitted, and then they are reproduce in the apparatus for decoding object data.

In some cases, these objects 1 through 3 may be regulated to reproduce or display by regulations of a certain state or nation. Further, an age of audience may be regulated by a rating related to a degree of sexuality or violence.

In the case that displaying the bunny girl of object 3, for example, is not desirable, the bunny girl of object 3 is replaced by another object and the other object is reproduced and displayed.

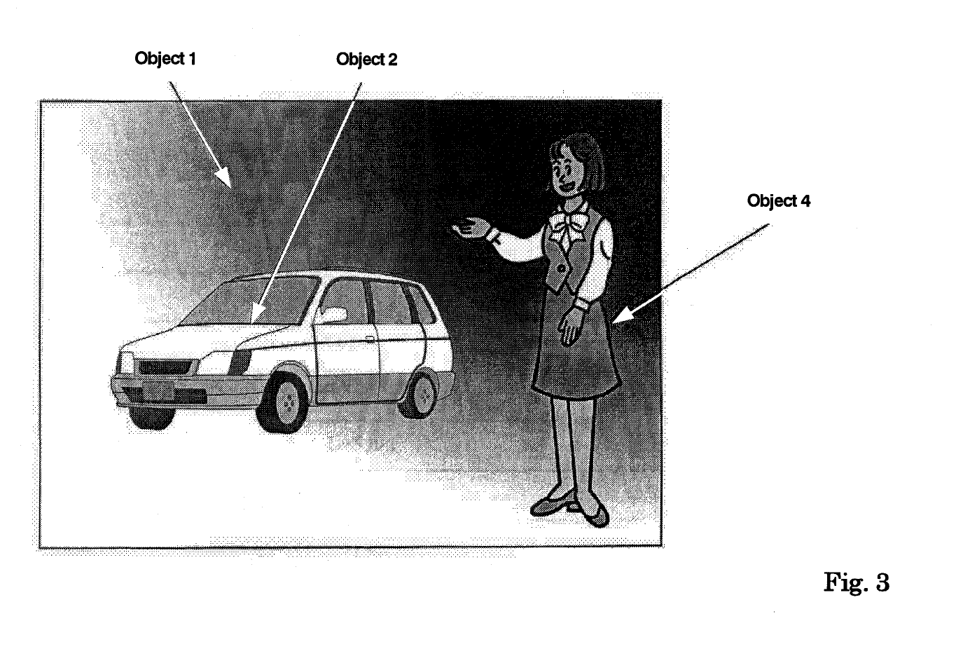

FIG. 3 is another example of a picture displayed on a screen, wherein the object 3 in FIG. 2 is replaced by an object 4.

In FIG. 3, as mentioned above, the bunny girl of object 3 in FIG. 2 is restricted to display, so that it is replaced by the object 4, a lady in uniform.

The encoding method of object data processed by the MPEG-4 system is an information compression method for transmitting or recording and reproducing encoded each object data. In the transmission side, a plurality of object data is transmitted. In the reproduction side, only some object data selected out from the plurality of object data transmitted are displayed or presented.

Such a selection of object data is conducted by a region code, which may be assigned by each state or nation, and a rating information, which may be assigned by a parent so as to restrict a child to see the object in accordance with an age of the child. The encoding method of object data, the region code, the rating code information and the picture displayed on a screen in accordance with these informations are detailed above. A construction and operations of an apparatus for encoding object data are explained next.

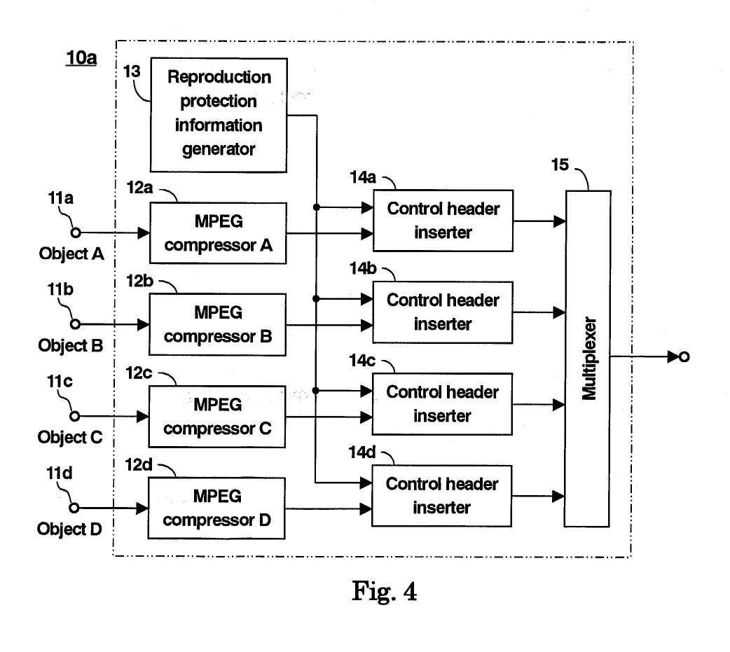

FIG. 4 is a block diagram of a first apparatus for encoding an object data according to the embodiment of the present invention.

In FIG. 4, constitution-wise, a first apparatus 10a for encoding an object data (hereinafter referred to as first encoding apparatus 10a) is similar to the apparatus 10 for encoding an object data shown in FIG. 1. The apparatus 10 is exhibited as an apparatus for encoding two objects. However, the first encoding apparatus 10a is exhibited in FIG. 4 as an apparatus for encoding four objects A through D, which are processed through four MPEG compressors A 12a through D 12d (hereinafter referred to as MPEG compressors 12a through 12d).

First of all, the background of object 1, the automobile of object 2, the bunny girl of object 3 and the lady in uniform of object 4, which are shown in FIGS. 2 and 3, are edited by an editor (not shown) and formed as objects A through D respectively. Signals corresponding to the objects A though D are supplied to input terminals 11a through 11d as object data A through D.

The object data A through D are supplied to MPEG compressors 12a through 12d respectively and compression-encoded. Respective signals obtained by the compression encoding are supplied to each of control header inserters 14a through 14d.

A trigger signal, which is in response to a processing time of encoding object data in the MPEG compressors 12a through 12d, is generated by a CPU (Central Processing Unit), not shown, and supplied to a reproduction protection information generator 13. In the reproduction protection information generator 13, a region code and a rating information corresponding to each of the object data A through D, are produced as a reproduction protection information and supplied to respective control header inserters 14a through 14d.

In each of the control header inserters 14a through 14d, the reproduction protection information corresponding to each of the objects A through D is added to the compression-encoded object data A through D as a header signal. These encoded signals of the object data A through D accompanied by the header signal are supplied to a multiplexer 15.

In the multiplexer 15, the object data A through D supplied in parallel from the control header inserters 14a through 14d are multiplexed and formed in a serial signal as a compression-encoded signal. The compression-encoded signal is outputted from the first encoding apparatus 10a.

The compression-encoded signal produced as mentioned above is supplied to the recording apparatus 20 and recorded thereby. In some cases, the compression-encoded signal is transmitted by a transmission apparatus (not shown), or supplied to a transmitting apparatus (not shown) and transmitted through a transmission medium (not shown).

Operations of reproducing and decoding such a compression-encoded signal, which is recorded or transmitted as mentioned above, are explained next.

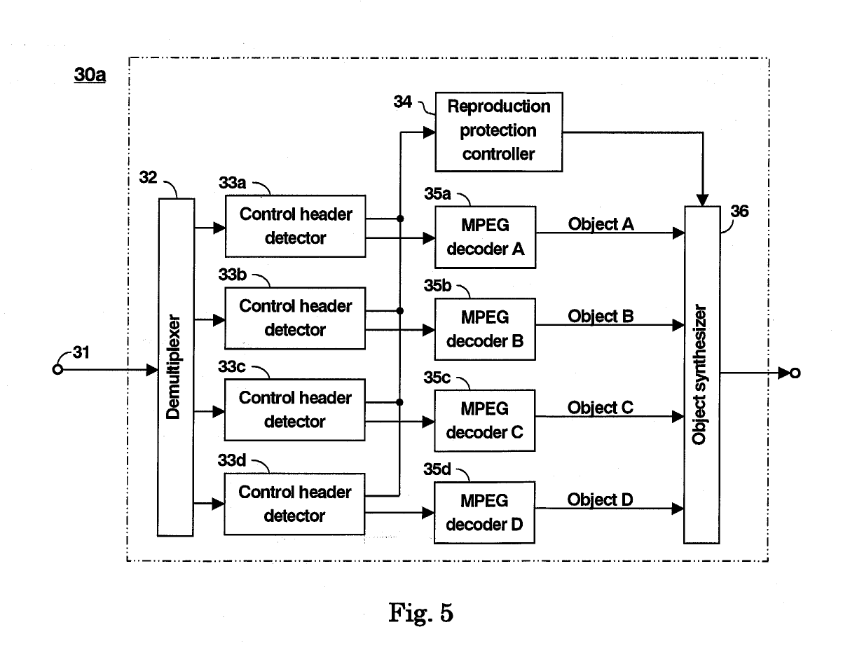

FIG. 5 is a block diagram of a first apparatus for decoding object data according to the embodiment of the present invention.

A first apparatus 30a for decoding object data (hereinafter referred to as first decoding apparatus 30a) shown in FIG. 5 is different from the apparatus 30 for decoding object data shown in FIG. 1 as such that the first decoding apparatus 30a reproduces four encoded objects in contrast to the apparatus 30 reproducing two encoded objects. Other functions and configurations are the same as those of the apparatus 30. Therefore, the same functions and operations are omitted to detailed.

The first decoding apparatus 30a decodes the compression-encoded signal encoded by the first encoding apparatus 10a shown in FIG. 4. Each of the object data A through D decoded by MPEG decoder 35a through 35d is supplied to an object synthesizer 36. In the object synthesizer 36, signals of some objects permitted to reproduce out of the objects A through D are synthesized as a video signal, and the video signal is outputted.

In the reproduction protection controller 34, each object is judged whether it is permitted to reproduce or not. As a result of judgment, a permitted object number is supplied to the object synthesizer 36. In the object synthesizer 36, a picture, which is composed of only objects permitted by the reproduction protection controller 34, is synthesized. The video signal obtained by the synthesized picture is outputted to a monitoring device (not shown) and displayed on a screen of the monitoring device (not shown).

The video signal displayed as mentioned above is such that it is the picture shown in FIG. 2 being synthesized by the object data A, B and C when the bunny girl to be reproduced as the object data C is permitted to reproduce. If the bunny girl of object data C is restricted to reproduce, the picture shown in FIG. 3, which is synthesized by the object data A, B and D, is outputted as a video signal.

The recording and reproducing object data of four objects is mentioned above. However, it is understood that a number of objects is not limited to four. Further, a type of object is not limited to a video component, any other object such as audio or audio signal component, graphic data and character code, which can be supplied as an information, can be applicable.

In a system exhibiting such a displaying effect, data must be constituted by each object of one picture. In the case of a picture compression method by the MPEG-4 System, a picture is compression-encoded by each object, and object data of each object is multiplexed and transmitted. In a receiver side, the multiplexed object data is received and demultiplexed. Then, each picture of each object is synthesized as one complete picture and displayed on a monitor screen.

In a recording apparatus side, a region code and a rating code are assigned with respect to each object picture. The assigned region and rating codes are compared with the same assigned in a reproducing apparatus side. A reproduction control for each object is conducted in accordance with the result obtained by the comparison.

A region code in a reproducing apparatus is assigned by one code specifying an area in where the reproducing apparatus is sold. The region code specifying the area is recorded in a memory element such as a ROM (Read Only Memory), which can not be rewritten by a user, when manufacturing the reproducing apparatus in a factory.

A rating code is assigned by a user in a reproducing apparatus side. For example, if the user is under age, a parent of the user can assign a level of rating to be reproduced in consideration of an educational problem or like by using a password or an ID number. In this case, the user, who does not know the password or the ID number, can not change the level of rating.

As mentioned above, a method of reproduction control by transmitting information of region and rating codes through a control header information to be added to each object data is explained. Another method of transmitting the information, which is convoluted in an information signal supplied by an electronic watermark, is depicted next.

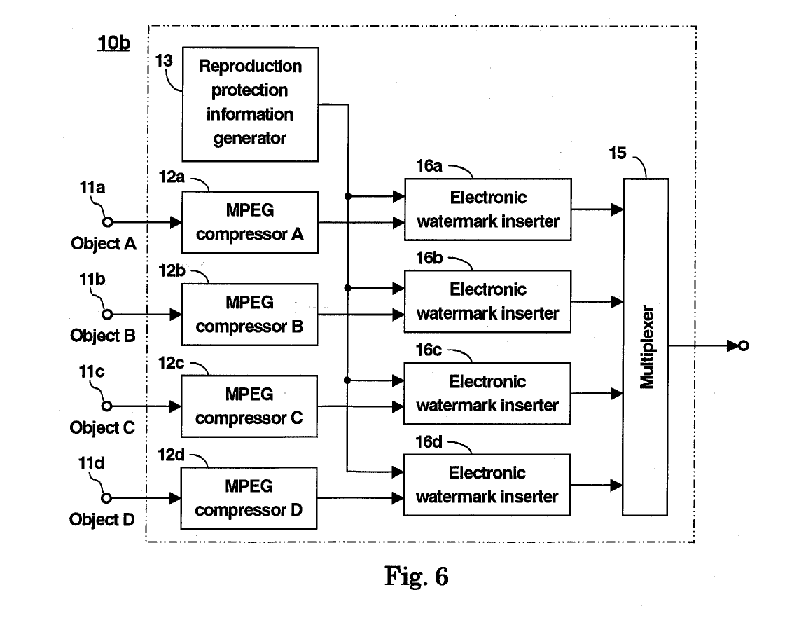

FIG. 6 is a block diagram of a second apparatus for encoding object data, which produces a compression-encoded data for each object by using a watermarking method.

In FIG. 6, a second apparatus 10b for encoding object data (hereinafter referred to as “second encoding apparatus 10b”) is composed of four MPEG compressors A 12a through D 12d (hereinafter referred to as MPEG compressors 12a through 12d), a reproduction protection information generator 13, four electronic watermark inserters 16a through 16d, a multiplexer 15 and four input terminals 11a through 11d for respective object data A through D. A region code information and a rating code information for each of the object data A through D are generated in the reproduction protection information generator 13 and supplied to the electronic watermark inserters 16a through 16d respectively.

In the electronic watermark inserters 16a through 16d, the region code or the rating code in accordance with each of the object data A through D is inserted into each of the encoded object data A through D.

The electronic watermark inserters 16a through 16d insert these codes to each of the compressed object data supplied from the MPEG compressors 12a through 12d by a method of rather easier to decode information of the electronic watermark and a method of lessening deterioration of coding quality related to each object data.

The encoded signal of each object data inserted with the electronic watermark as mentioned above is supplied to the multiplexer 15. In the multiplexer 15, these four encoded object data are multiplexed and resulted in a compressed data. The compressed data of encoded object data originally is recorded by the recording apparatus 20 shown in FIG. 1 or transmitted through a network, not shown.

Reproducing such an encoded object data recorded or transmitted is explained next.

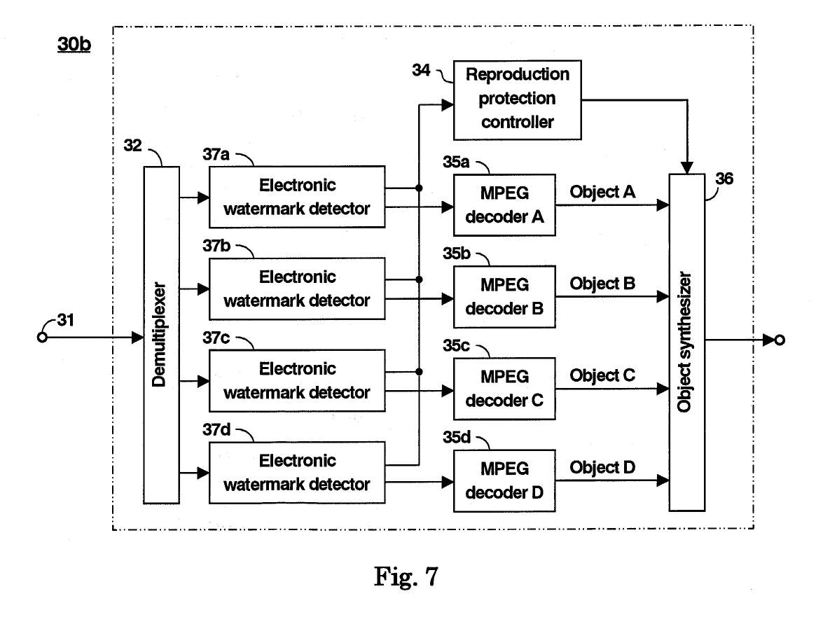

FIG. 7 is a block diagram of a second apparatus for decoding object data by detecting a reproduction protection signal, which is inserted into the object data by the electronic watermarking method.

In FIG. 7, a second apparatus 30b for decoding object data (hereinafter referred to as “second decoding apparatus 30b”) is identical to the first decoding apparatus 30a shown in FIG. 5 except for electronic watermark detectors 37a through 37d. Therefore, explanation of the same functions and operations as those of the first decoding apparatus 30a are omitted.

In the second decoding apparatus 30b, the compressed data of encoded object data processed by the second encoding apparatus 10b shown in FIG. 6 is supplied to the demultiplexer 32 through an input terminal 31 and demultiplexed into respective encoded object data A through D having a respective reproduction protection signal inserted into the encoded object data. The inserted reproduction protection signals of the object data A through D are detected by the electronic watermark detectors 37a through 37d respectively. Each of the detected reproduction protection signals is supplied to the reproduction protection controller 34.

In the reproduction protection controller 34, each of the object data A through D to be supplied to the object synthesizer 36 is judged whether it is permitted to reproduce or not in accordance with the reproduction protection information. As a result of judgement, an object number of object data permitted to reproduce is supplied to the object synthesizer 36. Each of signals demultiplexed by the demultiplexer 32 passes through the respective electronic watermark detector 37a through 37d is decoded by the respective MPEG decoders 35a through 35d and resulted in each of the object data A through D and supplied to the object synthesizer 36.

In the object synthesizer 36, a signal related to each of object data, which is permitted to reproduce, out of the object data A through D supplied to the object synthesizer 36 is synthesized into a picture (video) signal. The synthesized video signal into one complete picture is outputted externally.

As mentioned above, an encoding apparatus of object data and a decoding apparatus of object data, which control an object to be displayed or not in accordance with a reproduction protection information inserted into an encoded object data and reproduce an object data suitable for displaying, can be constituted.

An operation of reproduction protection control, which conducts such a displaying control, is explained next.

The reproduction protection control is performed by a reproduction protection information of each object, which is generated by the reproduction protection information generator 13 shown in FIGS. 1, 4 and 6. The reproduction protection signal is, for example, a region code designating an area in where a content can be reproduced, or a rating code related to restricting an age of audience.

Such a signal of reproduction protection information is generated by the reproduction protection information generator 13. The generated reproduction protection information is embedded in an encoded object data through a control header or by the electronic watermarking method and transmitted to the reproduction protection controller 34.

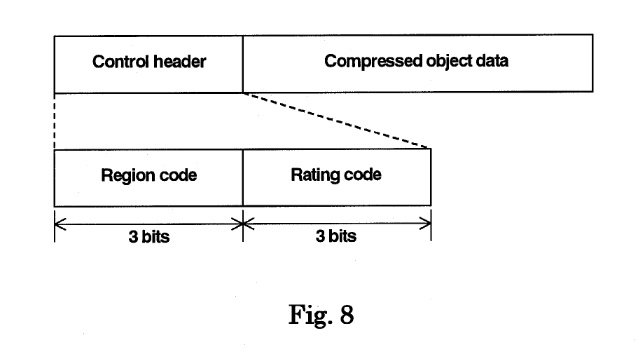

FIG. 8 shows a data format of reproduction protection information transmitted through a control header.

In FIG. 8, a control header is added in front of a compressed object data. The control header is further composed of a region code and a rating code.

In the case that a number of code types is assumed to be five, for example, 3 bits can conduct their expression totally. Therefore, the region code and the rating code are assigned by 3 bits respectively.

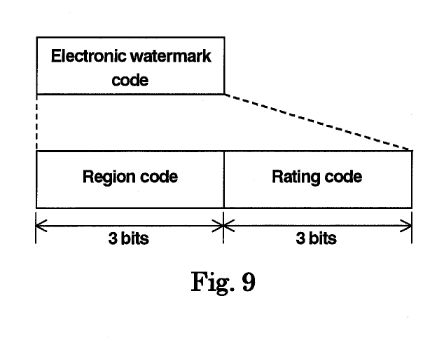

FIG. 9 shows a data format of reproduction protection information transmitted by the electronic watermarking method.

In FIG. 9, an electronic watermark code embedded in a compression-encoded object signal is composed of a 3-bit region code and a 3-bit rating code exactly the same as those of the control header shown in FIG. 8.

A coding example of region code and rating code is detailed next.

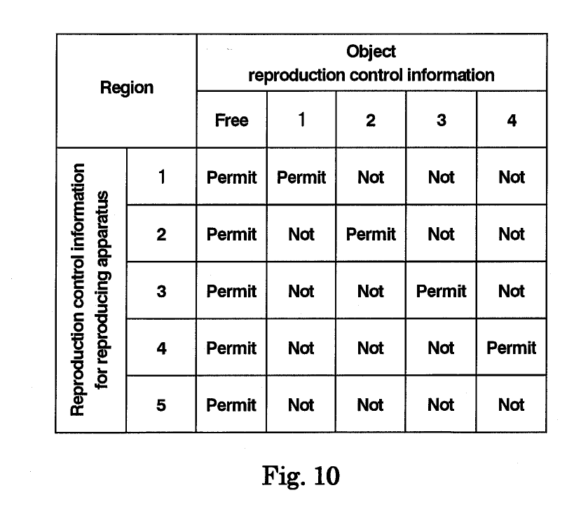

FIG. 10 shows an exemplary region code in five types. In FIG. 10, five types of reproduction control information 1 through 5 for a reproducing apparatus are assigned to exhibit specific five areas such that No. 1 is the U.S.A. and No. 2 is Japan, for example. Therefore, a reproducing apparatus sold in Japan is given by the region code No. 2, that is, “010” in 3 bits.

Further, an object reproduction control information assigned by each of objects 1 through 4 is described as an object reproducing information as shown in FIG. 10. In the case of the first line headed by the reproduction control information “1”, an object, which is permitted to be reproduced in the U.S.A. exclusively, is marked “1” and recorded as an object reproduction control information. In the case of the second line headed by reproduction control information “2”, an object permitted to be reproduced only in Japan, is marked “2” and recorded as an object reproduction control information “2”.

Furthermore, in the case that any objects can be reproduced in any areas, an object reproduction control information is marked and recorded by “FREE”. The code “FREE” is assigned by a code “0” and transmitted. The code “FREE” is used for signifying that reproduction is permitted by any reproducing apparatuses for any areas.

The reproduction protection controller 34 judges a certain object whether it is permitted to reproduce or not in accordance with the chart shown in FIG. 10. The region shown in FIG. 10 exhibits one area with respect to one code. However, another method such as assigning a code exhibiting a plurality of areas as an optional method and recording the code as a region code can be applicable.

A method of recording the plurality of area codes is provided with several cases such as recording an object reproduction control information of each area code and assigning a code exhibiting enabling to reproduce in a plurality of areas. In these cases, a region code is expanded to more than 3 bits and described.

A region code information is transmitted as mentioned above. A rating code is detailed next.

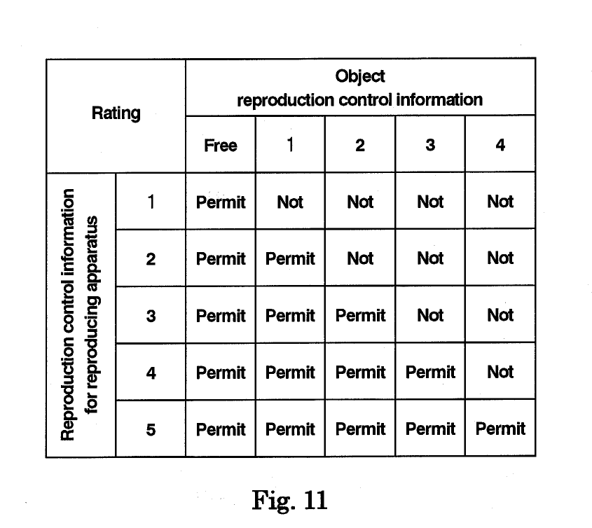

FIG. 11 is a chart showing a relationship between a reproduction control information for a reproducing apparatus, which is controlled by a rating code whether an object is permitted to reproduce or not, and an object reproduction control information.

The reproduction protection controller 34 judges a relationship between a rating code supplied to the reproduction protection controller 34 and another rating code assigned to a reproducing apparatus and determines whether an object is permitted to reproduce or not.

The wording “Permit” and “Not” shown in FIG. 11 represents “permitted to reproduce” and “not permitted to reproduce” respectively. They are exhibited as a relationship between a level of rating given by the reproduction control information 1 through 5 for a reproducing apparatus and another level of rating inherent to each object as an object reproduction control information.

The reproduction control information for a reproducing apparatus is assigned such that, for example, a rating level “1” is for a child of 13 yeas old or less and a rating level “2” is for a youth of 16 years old or less. A rating of object reproduction information is assigned with respect to each object, and an object reproduction control information is specified in accordance with the rating.

An object is reproduced in accordance with the specified object reproduction control information. In the case that a rating code of reproducing apparatus is assigned to “4”, for example, any objects, which are assigned to any rating levels of 1 through 4, are permitted to reproduce.

As mentioned above, a code related to a region and rating and a reproduction table related to an object whether the object is permitted to reproduce or not are produced. An object is controlled whether the object is exhibited or not in accordance with the reproduction table. Only an object permitted to exhibit is supplied to the object synthesizer 36 and synthesized as a video signal, and then the video signal is outputted to an output terminal.

An example of assigning a region code to an object in an actual program for reproducing contents (hereinafter referred to as “reproduction program”) is exhibited and permitting or not permitting to reproduce an object is depicted next.

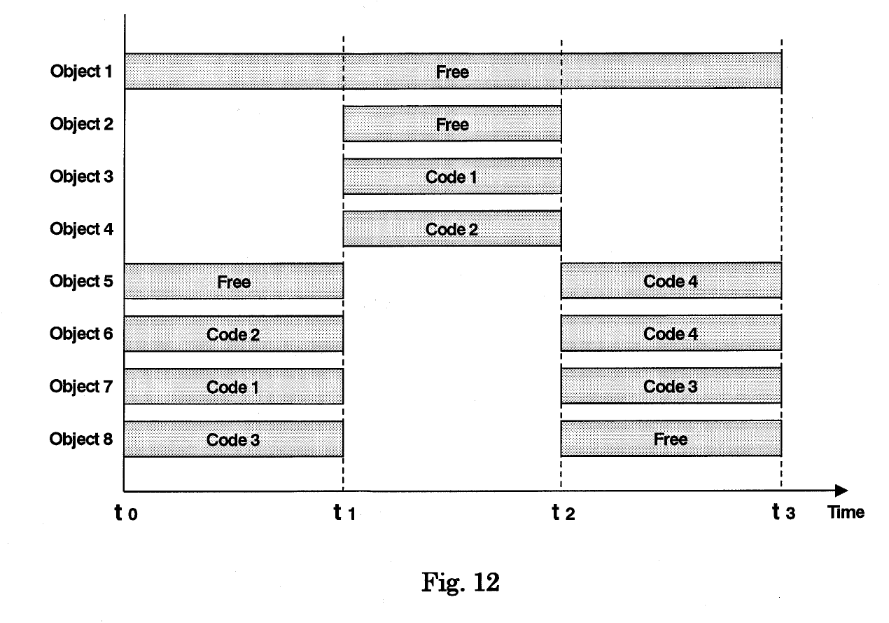

FIG. 12 is an exemplary chart showing a relationship between an object to be recorded and a region code.

In FIG. 12, the horizontal line is a time axis. A reproduction program for reproducing objects 1 through 8 is spread along the vertical line (the Y-axis). The reproduction program is recorded during a time period from a time “t0” to a time “t3”. During the time period from “t0” to “t1”, region codes of objects 1, 5, 6, 7 and 8 are assigned to “FREE”, “FREE”, “Code 2”, “Code 1” and “Code3” respectively.

Further, during the time period from “t1” to “t2”, region codes of objects 1, 2, 3 and 4 are assigned to “FREE”, “FREE”, “Code 1” and “Code 2” respectively. Furthermore, during the time period from “t2” to “t3”, region codes of objects 1, 5, 6, 7 and 8 are assigned to “Code 4”, “Code 4”, “Code 3” and “FREE” respectively.

In a case that a region code of a reproducing apparatus of object data is assigned to “1”, only objects assigned to “FREE” and “Code 1” out of these objects 1 through 8 are permitted to reproduce.

The objects, which are displayed during the time period from the time “t1” to the time “t2”, are described next.

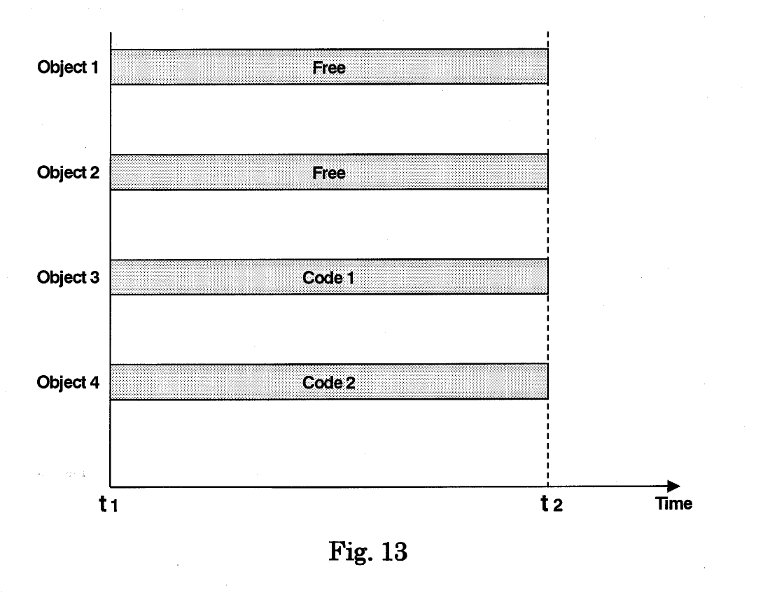

FIG. 13 shows a reproduction program of the objects 1 through 4 during the time period from the time “t1” to the time “t2” shown in FIG. 12.

In this assignment of the reproduction program shown in FIG. 13, if a region code of a reproducing apparatus is assigned to “1”, a reproduced picture during this time period is composed of the background of object 1, the automobile of object 2 and the bunny girl of object 3 as shown in FIG. 2.

When the region code of the reproducing apparatus is assigned to “2”, only objects assigned to “FREE” and “Code 2” are permitted to reproduce and displayed as a picture, that is, a picture composed of the background of object 1, the automobile of object 2 and the lady in uniform of object 4 is displayed as shown in FIG. 3.

A picture assigned in accordance with a region code is displayed as mentioned above. An object, which is assigned a rating code and displayed, is explained next.

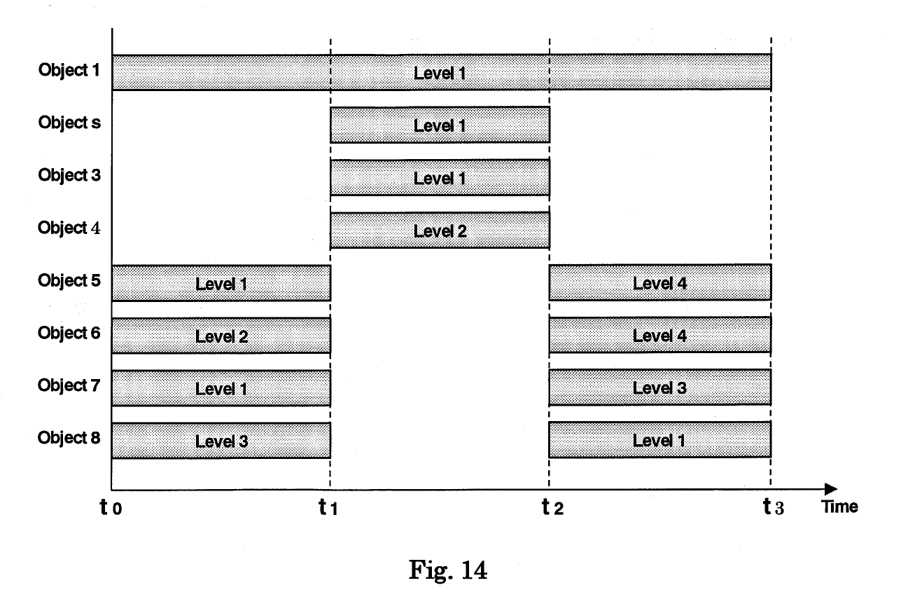

FIG. 14 shows a status of object recorded with assigning a rating during a time period from a time “t0” to a time “t3”.

In FIG. 14, rating codes of objects 1, 5, 6, 7 and 8 are assigned to “Level 1”, “Level 1”, “Level 2”, “Level 1” and “Level 3” respectively and recorded as a reproduction program during a time period from the time “t0” to the time “t1”. Further, rating codes of objects 1, 2, 3 and are assigned to “Level 1”, “Level 1”, “Level 1” and “Level 2” respectively and recorded as a reproduction program during a time period from the time “t1” to the time “t2”. Furthermore, rating codes of objects 1, 5, 6, 7 and 8 are assigned to “Level 1”, “Level 4”, “Level 4”, “Level 3” and “Level 1” respectively and recorded as a reproduction program during a time period from the time “t2” to the time “t3”.

With respect to a reproduction of the objects recorded as mentioned above, when a rating code of a reproducing apparatus is assigned to “Level 1”, only objects of which rating code is assigned to “Level 1” or less are permitted to reproduce.

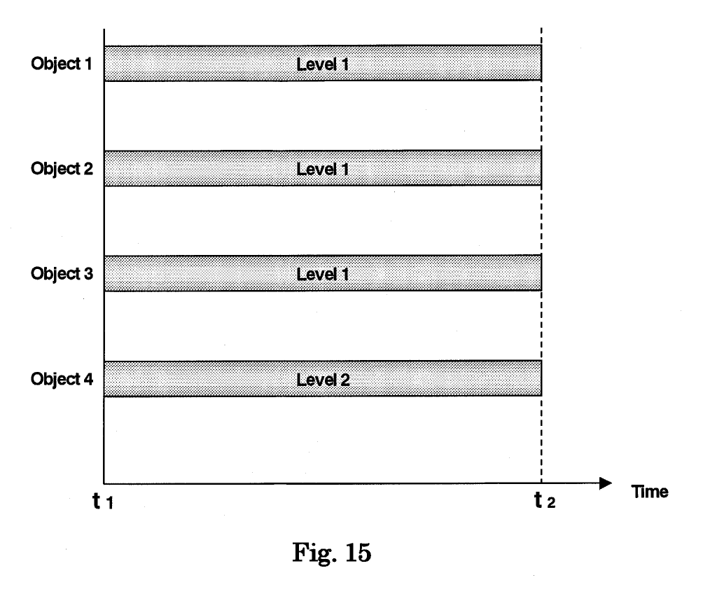

FIG. 15 shows a reproduction program of the objects 1 through 4 during the time period from the time “t1” to the time “t2” shown in FIG. 14.

In FIG. 14, during the time period from the time “t1” to the time “t2”, objects synthesized by the object synthesizer 36 are the background of object 1, the automobile of object 2 and the bunny girl of object 3 as shown in FIG. 2 when a rating code of a reproducing apparatus is assigned to the “Level 1”.

Further, when a rating code assigned to a reproducing apparatus is the “Level 2”, reproduction permission is given to objects having a rating code of “Level 2” or less. A picture to be reproduced is either one of the picture shown in FIG. 2, which is composed of the background of object 1, the automobile of object 2 and the bunny girl of object 3, and the other picture shown in FIG. 3, which is composed of the background of object 1, the automobile of object 2 and the lady in uniform of object 4.

In this case, a plurality of pictures, which are synthesized by a plurality of combinations of objects in accordance with a rating code of the reproducing apparatus, can be displayed. Displaying any one of the plurality of pictures enabling to be reproduced arrives at one of setting items of the reproducing apparatus. The setting is a designing matter.

The constitution and operations of the recording and reproducing system for object data are explained above, wherein objects are selected in accordance with a rating code and a region code, and a picture to be displayed is synthesized.

In the decoding apparatuses 30a and 30b shown in FIGS. 5 and 7, the operations are explained as a method such that the encoded signals of four objects A through D are supplied to and decoded by the four MPEG decoders 35a through 35d, and then the decoded object data are synthesized by the object synthesizer 36 under controlling of the reproduction protection controller 34.

The reproduction related to a woman is either one of the bunny girl of object 3 shown in FIG. 2 and the lady in uniform of object 4 shown in FIG. 3.

In a case that an object to be reproduced is assigned by a reproduction protection information, decoding an object other than the assigned one is not necessary. In a case of the embodiment mentioned above, it is realized by that compression-encoded signals supplied to the MPEG decoders are switched over from each other so as to decode either one object data of the object 3 and object 4.

By assigning an object before decoding a compression-encoded signal, quantity of the MPEG decoders can be decreased, and then a constitution of decoding apparatus of object data can be simplified.

In this embodiment, typical objects are exhibited by four and a method of reproduction protection for the objects is explained above. However, in a practical application, displaying control is performed by a method such that one object is further divided into a plurality of elements (objects) such as, for example, clothing, a cap or hat, a wheel of automobile and each part of background, and they are assigned to respective object numbers. Therefore, one picture is divided into a plurality of objects and the plurality of objects is organized so as to be controlled by their statuses of being displayed or not. Consequently, quantity of objects not to be displayed increases.

Further, an object is not limited to a video image. Speech of a specific person can be assigned to an audio object. There is existed a method of controlling such an audio object by linking the audio to a picture of the specific person as one object of the picture and another method of controlling the audio object by linking the audio to a background picture as an audio information of BGM (Back Ground Music). In a case that a number of objects increases, such methods are more effective.

In a case that an audio information is linked as mentioned above, it is acceptable that an electronic watermark can be mixed with not only a video signal but also an audio signal. In a case that an object information is encoded with having redundancy, it is also acceptable that an electronic watermark can be inserted into other information signal linking to the video signal or the audio signal.

In such cases, an electronic watermark information can be embedded in an information shown as “FREE” in FIG. 10. An object assigned to “FREE” is always decoded, so that the electronic watermark information is also decoded at all times. Consequently, such a method of embedding an electronic watermark information is high in convenience.

In order to permit reproduction of each object in accordance with a region information and a rating information, a reproduction control information signal is produced as mentioned above. By using the reproduction control information signal, the encoding method of object data for controlling reproduction of each of compression-encoded object data, the decoding method of the object data, the encoding apparatus of the object data installing the encoding method and the decoding apparatus of the object data installing the decoding method are detailed in their constitutions.

In these exemplary constitutions, it is explained that all objects are recorded in the hard disc 21. However, the recording apparatus 20 is composed of a plurality of recording mediums, so that it is acceptable that those objects are recorded in the hard disc and a DVD-RAM disc simultaneously or separately.

Further, the object data is recorded in another recording medium other than the recording apparatus 20. Therefore, the object data can be obtained by accessing to the other recording medium through a network. An apparatus for transmitting object data signal through a network and another apparatus for receiving the object data signals are explained next.

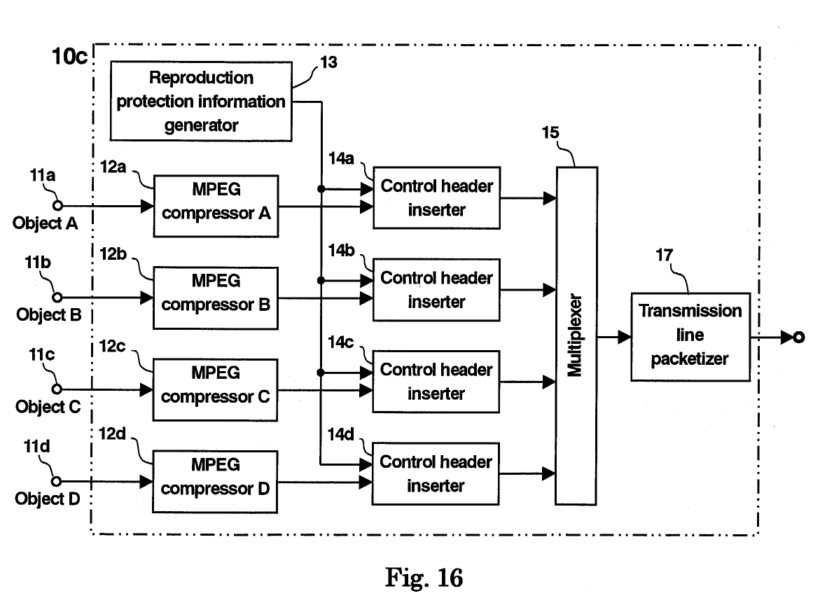

FIG. 16 is a block diagram of an apparatus for producing an encoded object data signal, which produces an encoded signal using a control header for transmission.

In FIG. 16, an apparatus 10c for producing an encoded object signal (hereinafter referred to as “producing apparatus 10c”) is identical to the first encoding apparatus 10a shown in FIG. 4 except for a transmission line packetizer 17. The transmission line packetizer 17, which is supplied with a multiplexed and compressed data from the multiplexer 15, generates a packetized multiplexed compression-encoded signal and supplies the packetized multiplexed compression-encoded signal to a transmission line.

The packetized multiplexed compression-encoded signal to be supplied to a transmission line is formatted in a bit stream, which is specified by the MPEG System Standard. The MPEG System Standard specifies a signal format composed of two bit streams of TS (Transport Stream) and PS (Program Stream).

The TS and PS are composed of a plurality of packets containing PES (Packetized Elementary Stream) and other necessary information. The PES is specified as an intermediate stream enabling to convert a TS to a PS or vice versa, and obtained by packetizing a stream such as a private stream other than video and audio data encoded by the MPEG Standard.

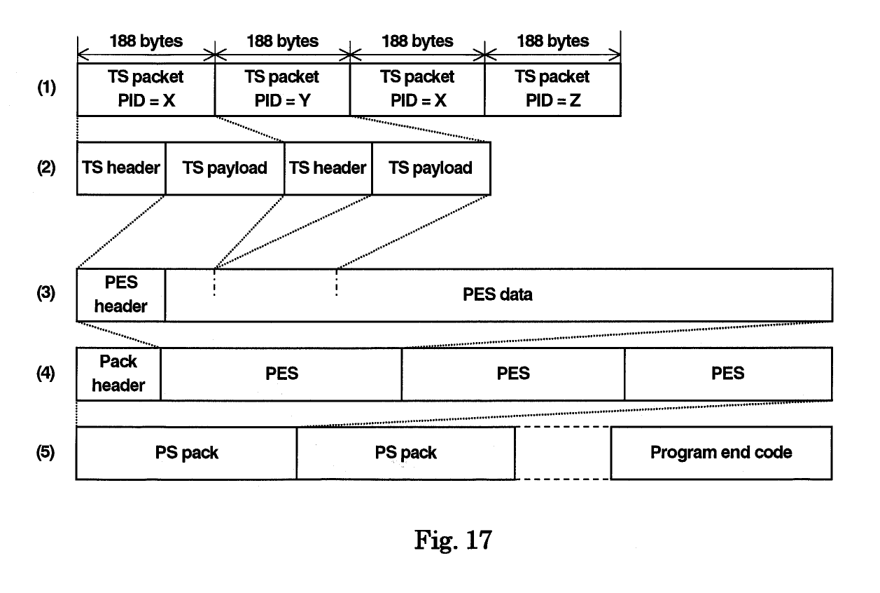

FIG. 17 shows a data configuration of TS, PS and PES and a relationship among them. In FIG. 17, a transport stream (TS) is composed of a plurality of TS packets having a fixed length of 188 bytes as shown in the first line (1). One TS packet having a packet ID of x (PID=x) is composed of a TS header and a TS payload as shown in the second line (2).

On the other hand, a program stream (PS) is composed of a plurality of PS packs as shown in the fifth line (5). One PS pack is composed of a pack header and a plurality of packetized elementary streams (PES) as shown in the fourth line (4). One PES is composed of a PES header and PES data as shown in the third line (3).

Further, a plurality of TS payloads including a PES header is described in one PES area and resulted in connecting a TS and a PS with each other. Consequently, mutual conversion between a PS and a TS is enabled.

As mentioned above, both streams of TS and PS are configured. In a case of a standard (STD) model of decoding a PS, a stream to be decoded is obtained and decoded by a “stream_id” described in a PES header.

In a case of a STD model of decoding a TS, a multiplexed video and audio signal of a program software having a reference time in common can be decoded as same as a decoder for PS. In a case of transmitting a TS signal, a multiplexed transmission of multi-programs in telecommunications and broadcasting having a reference time different from each program is enabled.

In a case that a TS is transmitted through an ATM (Asynchronous transfer Mode) line, a packet size used for transmission is assigned to a fixed length of 188 bytes. However, in consideration of a cell length and error correction decoding, a packet size is flexible so as to transmit suitably a TS packet even though an error exists in a transmission line.

A compression-encoded signal, which is processed through such a data configuration and, packetized, is supplied to a transmission line or network such as the Internet. The packetized compression-encoded signal is received by a receiving apparatus of encoded object signal connected to the network.

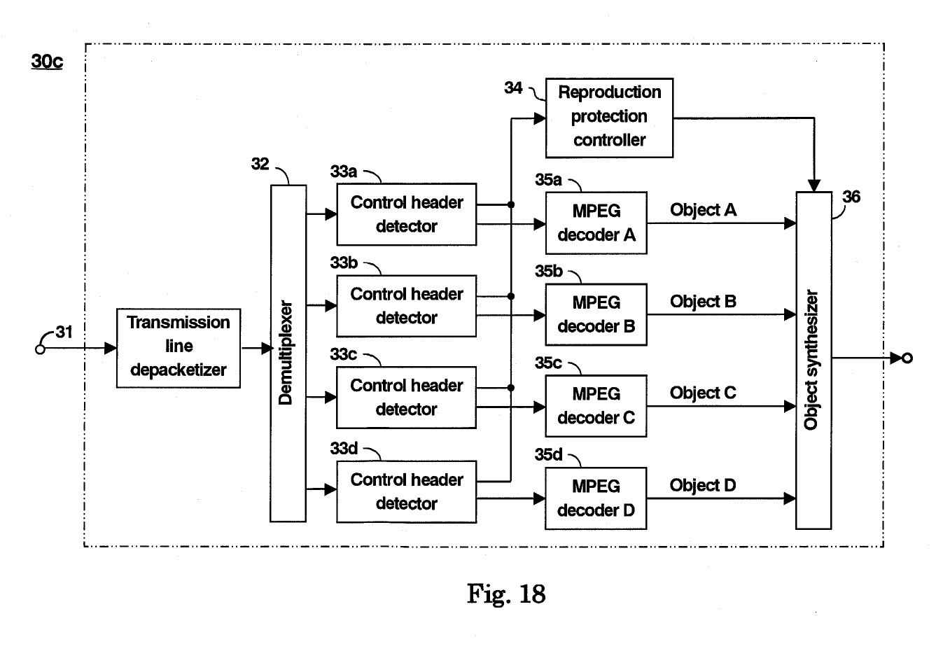

FIG. 18 is a block diagram of a first receiving apparatus of object data, which obtains a received signal by detecting a control header added to a packetized compression-encoded signal.

In FIG. 18, a first receiving apparatus 30c of object data is identical to the first decoding apparatus 30a shown in FIG. 5 except for a transmission line depacketizer 38. A signal from a transmission line is supplied to the transmission line depacketizer 38 and depacketized therein resulting in a compressed data. The compressed data is supplied to the demultiplexer 32.

A signal transmitted through a transmission line is depacketized by the transmission line dpacketizer 38, which performs an operation complementary to that of the transmission line packetizer 17 shown in FIG. 16, and released from a packetized signal as a compressed data of compression-encoded signal. The compressed data composed of only a plurality of payloads is supplied to the demultiplexer 32 and processed through the same operations as the decoding apparatus 30a in FIG. 5, and finally a synthesized signal of desired objects is produced. The produced synthesized signal is supplied to a monitor TV (not shown) and displayed.

The method of transmitting an information of region code and rating code in accordance with a control header information added to object data, and of controlling reproduction while receiving is explained above. A method of transmitting an information of region code and rating code by convoluting the information with an object data by the electronic watermarking method is depicted next.

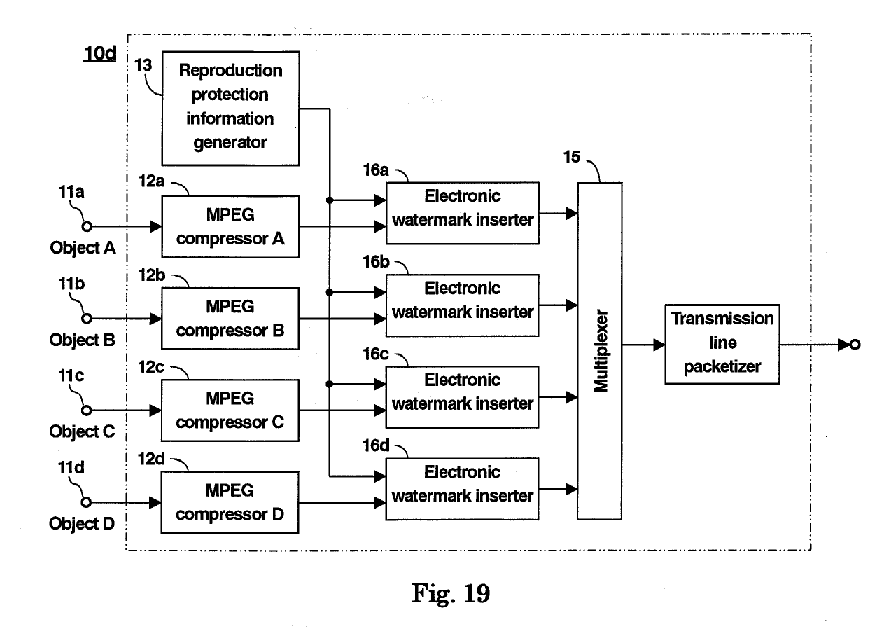

FIG. 19 is a block diagram of a first transmitting apparatus of object data, which produces a compression-encoded object data by using the electronic watermarking method and transmits the compression-encoded object data. With referring to FIG. 9, its operation is explained next.

In FIG. 19, a first transmission apparatus 10d is identical to the second encoding apparatus 10b shown in FIG. 6 except for a transmission line packetizer 17. The transmission line packetizer 17 packetizes a multiplexed compression-encoded object data, which is supplied from the multiplexer 15, for a packet signal supplied to a transmission line or network.

Each information of region code and rating code for each of the objects A through D, which is generated by the reproduction protection information generator 13, are supplied to the electronic watermark inserters 16a through 16d respectively. In each of the. electronic watermark inserters 16a through 16d, a region code and a rating code corresponding to each of encoded signals of objects A through D are inserted into respective compression-encoded object data as a watermark data by the electronic watermarking method.

The compression-encoded object data inserted with the electronic watermark information are supplied to the multiplexer 15 and multiplexed therein. The multiplexed compression-encoded object data is packetized by the transmission line packtizer 17 and supplied to a transmission line, and then transmitted through a network (not shown).

A receiving apparatus of such a packetized compression-encoded object data, which is transmitted as mentioned above, is described next.

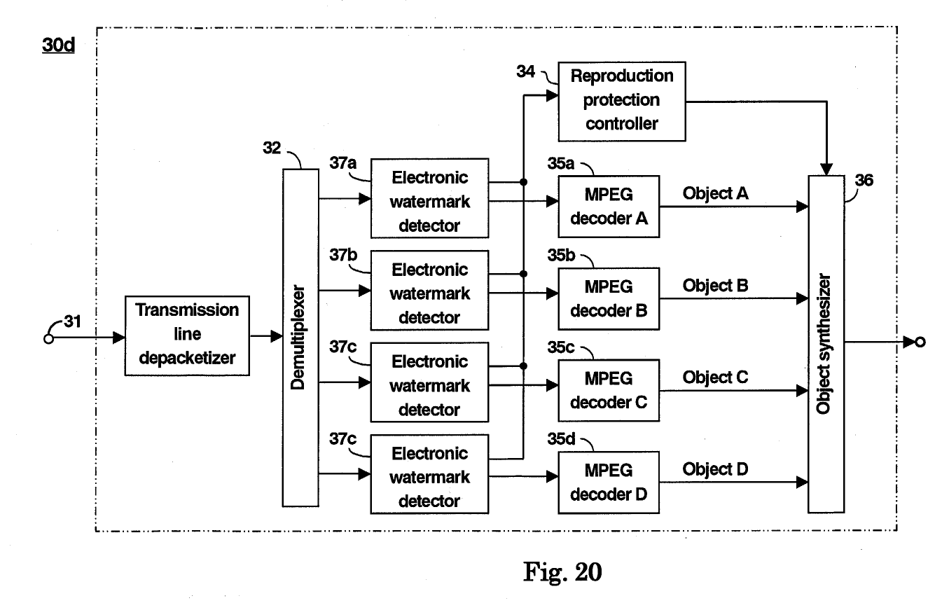

FIG. 20 is a block diagram of a second receiving apparatus of object data, which detects a reproduction protection information signal inserted into a compression-encoded object data by the electronic watermarking method and decodes the compression-encoded object data for displaying.

In FIG. 20, a second receiving apparatus 30d is identical to the second decoding apparatus 30b shown in FIG. 7 except for a transmission line depacketizer 38, which releases the packetized compression-encoded object data by a complementary method to the packetizing method conducted by the transmission line packetizer 17 shown in FIG. 19.

Each reproduction protection information signal for each object, which is inserted into a compression-encoded object data by the electronic watermark inserters 16a through 16d, is detected by the electronic watermark detectors 37a through 37d respectively. Each of object data decoded by the MPEG decoders 35a through 35d is judged whether the object data is permitted to reproduce or not in accordance with the detected each reproduction protection information signal. As a result of judgement, an object data signal related to an object permitted to reproduce is synthesized for a picture to be reproduced and the synthesized picture signal is outputted.

As mentioned above, displaying or not displaying an object is controlled by a reproduction protection information, which is convoluted in an encoded object data. Consequently, a transmitting and receiving apparatuses for reproducing an object suitable for displaying can be realized.

By using such a producing, transmitting or receiving apparatus, object data accumulated in a terminal equipment or a server equipment connected to a network are stored as data that a reproduction control signal of each element of object is inserted. Further, the object data themselves are accumulated in another server equipment installed in a different location or site from that of the server equipment. In a case that a lot of object data is stored in many server equipment, the server equipment are organized so as to synthesize a picture in higher quality.

By using objects, which are permitted to reproduce in accordance with a plurality of region codes and rating codes, the constitution and method of synthesizing the objects and obtaining a video signal are mentioned above. Further, by using a coding information, which provides reproduction permission or restriction, similar to a reproduction protection information, an encoding method and a decoding method similar to those mentioned above can be realized.

A computer system is used for a process of synthesizing object data in accordance with such a coding information. In some cases, synthesizing object data is performed in a RAM (Random Access Memory) or a frame memory connected to the computer system.

A computer program executing a computer system for synthesizing object data is explained next.

First of all, a program of encoding process and transmitting encoded data is explained when a reproduction protection control signal is added to an object data by using a control header as shown in FIGS. 4 and 16.

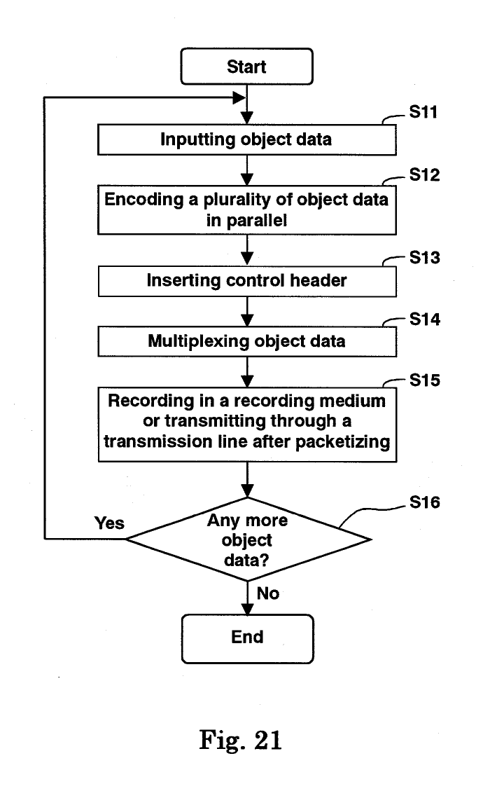

FIG. 21 is a first flow chart showing a program of encoding process of object data by inserting a control header into the object data. In FIG. 21, each execution program is exhibited by each step of encoding processes.

An object data of picture is supplied to an MPEG compressor as an input signal (step: S11). The supplied object data is compression-encoded in parallel and a plurality of compression-encoded signals corresponding to each object is produced (step: S12).

A control header is inserted into each of the plurality of compression-encoded signals (step: S13). A multiplexed data is produced by multiplexing the plurality of compression-encoded signals inserted with the control header (step: S14).

The multiplexed data produced as mentioned above is recorded in a recording medium or packetized in accordance with a signal format so as to be supplied to a predetermined transmission line, and then the packetized and multiplexed compression-encoded data is supplied to a transmission line (step: S15).

The compression-encoded data is recorded or transmitted as mentioned above. The steps S11 through S15 are repeated until it is detected that no more object data is left (step: S16). When all object data are recorded or transmitted, the processes come to end.

Reproducing object data, which are recorded or transmitted as mentioned in FIG. 21, is explained next.

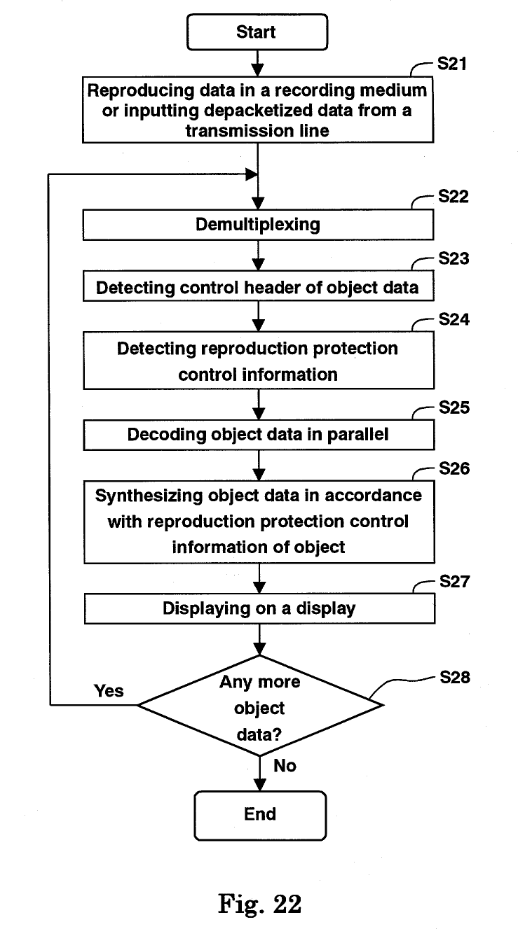

FIG. 22 is a second flow chart showing a program of decoding process for reproducing object data, which are recorded or transmitted with being added with a control header.

In FIG. 22, an object data recorded in a recording medium is reproduced, or a packetized object data supplied to a transmission line is inputted to a transmission line depacketizer and release from packetization, and then a compressed data composed of only payload is obtained (step: S21).

The obtained compressed data is supplied to a demultiplexer and separated into each object data (step: S22). Each control header for each object is detected from each object data (step: S23).

A reproduction protection control information is detected from the detected control header (step: S24). An object data of object, which is permitted to reproduce is decoded (step: S25) in parallel with the step S24.

The decoded each object data is synthesized in accordance with each reproduction protection control information for respective object (step: S26). A video signal obtained by synthesizing object data is displayed by a displaying device (step: S27).

It is detected whether any object data to be reproduced is remained or not (step: S28). The steps S22 through S27 are repeated until it is detected that no more object data is remained. The decoding process for reproducing object data comes to end when all object data are reproduced.

An operation of reproduction control for each object conducted by a computer system and the electronic watermarking method is explained with referring to a third flow chart.

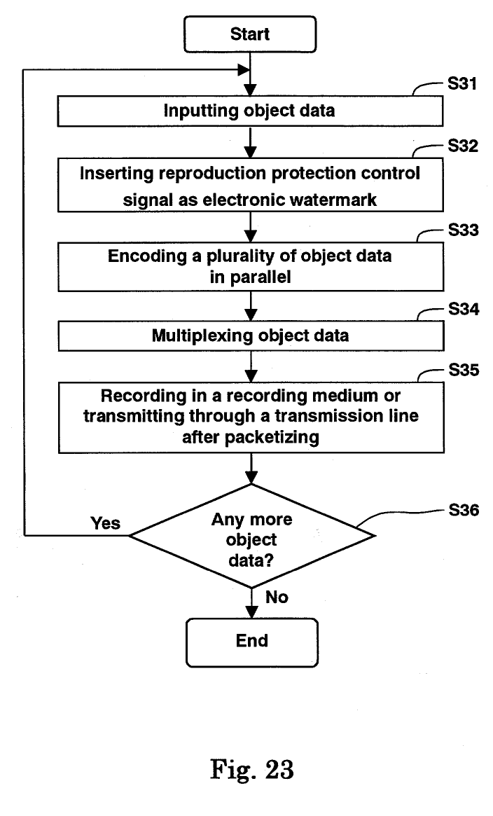

FIG. 23 is a third flow chart showing a program of decoding process and transmitting process of object data.

Operations shown in FIG. 23 relates to the operation of encoding apparatus 10b shown in FIG. 6 and the operation of first transmitting apparatus 10d shown in FIG. 19. In these apparatuses 10b and 10d, an electronic watermark is added to a compression-encoded signal. However, an operation method shown in FIG. 23 is such that an object data inserted with an electronic watermark data is compression-encoded and then transmitted.

A plurality of object data is supplied to a plurality of electronic watermark inserters respectively as an input signal (step: S31). Each of reproduction protection information signals related to reproducing each object is inserted into each of the plurality of object data respectively by the electronic watermarking method (step: S32).

Each of the plurality of object data inserted with electronic watermark data is supplied to respective MPEG compressors and a plurality of compression-encoded object data is produced in parallel as an encoded signal (step: S33).

Each of the plurality of compression-encoded object data is supplied to a multiplexer and multiplexed therein, and resulted in one multiplexed signal (step: S34).

The multiplexed signal produced in the step S34 is recorded in a recording medium, or packetized in a predetermined format and supplied to a transmission line (step: S35).

The plurality of compression-encoded object data is recorded or transmitted as mentioned above. The steps S31 through S35 are repeated until it is detected that no more object data remains (step: S36). The process comes to end when all object data are recorded or transmitted.

Reproducing object data recorded or transmitted as mentioned above is explained next.

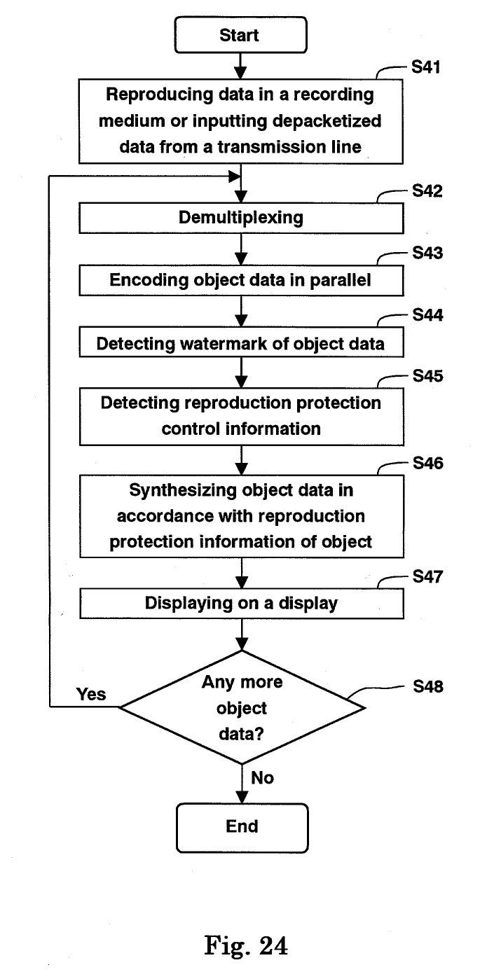

FIG. 24 is a fourth flow chart showing a program of decoding process of object data for reproducing the object data, which are recorded in a recording medium or transmitted with adding a control signal by the electronic watermarking method.

In FIG. 24, an object data recorded in a recording medium is reproduced, or a packetized object data supplied to a transmission line is inputted to a transmission line depacketizer and release from packetization, and then a compressed data composed of only payload is obtained (step: S41).

The obtained compressed data is supplied to a demultiplexer and separated into each object data (step: S42). Each object data is decoded in parallel (step: S43).

Such a decoding in parallel includes two cases: one is a case of decoding by using a plurality of MPEG decoders simultaneously, and the other is a case of executing one MPEG decoder operating in high speed and decoding a plurality of object data by the time sharing system (TSS) within a predetermined period of time.

Each object data decoded as mentioned above is supplied to an electronic watermark detector and the electronic watermark information inserted in the step S32 of FIG. 23 is obtained (step: S44). A protection control header corresponding to each object is detected in accordance with the obtained electronic watermark information (step: S45).

In accordance with the detected protection control header, object data of picture to be permitted to reproduce are synthesized (step: S46). A video signal obtained by synthesizing object data in the step S46 is supplied to a displaying device and displayed thereon (step: S47).

It is detected whether an object data to be reproduced remains or not (step: S48). The steps S42 through S47 are repeated until it is detected that no more object data to be reproduced is left. The process comes to end when no object data remains any more.

Each object data is recorded or transmitted as mentioned above. With respect to a software for displaying an object to be permitted to reproduce in a reproduction side, any software such as a software provided by an producer of object and a browser software of displaying a video image on the Internet can be acceptable, when obtaining a plurality of object data stored in a plurality of sites and synthesizing the plurality of object data and displaying the synthesized object data.

In a case of displaying by using a displaying software commonly available, it is necessary for a computer installing the displaying software not to display an object, which is restricted to be displayed, even though a region code previously assigned to the computer is rewritten.

In order to prevent a computer from rewriting a region code, such a region code to be registered in the computer must be recorded in a ROM (Read Only Memory) device. Further, in a case of a computer having no such a ROM device, the region code can be recorded in an encrypted electronic file so as for the region code not to be rewritten by a user.

Programs for encoding and decoding object data such that the programs execute a computer to perform an operation, which protects a reproduction protection control information embedded by the electronic watermarking method from being altered by a user, can be realized.

In apparatuses such as an encoding apparatus, a transmitting apparatus and a decoding apparatus of object data realized as mentioned above, a reproduction protection information signal for permitting reproduction in accordance with a region code or rating code is added to each object data.

It is acceptable that such a reproduction protection information signal gives a region code or a rating code to a plurality of objects grouped totally.

With respect to a method of giving reproduction permission in accordance with a region code or a rating code to the group of the plurality of objects, the MPEG-4 System Standard specifies that each ID code can be added to each of objects respectively, so that the MPEG-4 System Standard ca be used therefor.

The MPEG-4 System Standard provides a structure of scene description for displaying a scene by synthesizing a picture such that adding an ID code can define a group of objects and objects contained in the defined group of objects can be reproduced simultaneously.

Therefore, it is also possible to realize a method such as adding a reproduction protection information signal for permitting reproduction of the group of objects composed of the object 1, 2 and 3 shown in FIG. 2 in accordance with a region code or rating code, and adding another reproduction protection information signal for permitting reproduction of the group of objects composed of the object 1, 2 and 4 shown in FIG. 3 in accordance with another region code or rating code.

In the MPEG-4 Standard, the structure of scene description constituted as mentioned above is referred to as a BIFS (Binary Format for Scene).; Describing a scene, which is permitted to reproduce by the BIFS, is possible.

Describing a scene by using the BIFS is explained next.

The BIFS is constituted by two layers of scene description and multiplexing. There is existed a DMIF (Delivery Multimedia Integration Framework) under the multiplexing layer. With respect to the scene description, an interface is defined for the current transmission method such as a TS specified by the MPEG-2 System Standard, the H.223 Specification specified by the ITU-T (International Telecommunication Union Telecommunication Standardization Sector) and the IP (Internet Protocol).

On the other hand, with respect to the multiplexing, it is possible to describe multiplexing a various kind of objects as the BIFS. For example, it is possible to designate an object such as an audio signal, a moving picture, a CG (Computer Graphics) picture, a still picture and a text data to be synthesized as a scene.

Further, it is also possible to describe a constitution of allocating spatially or in time series a plurality of object information such as video information, audio information and text information by a scene describing language such as the BIFS.

Furthermore, the scene describing language can be express in a tree structure, and a node is defined as a unit of description and behavior. The node is provided with a various kind of nodes in accordance with a function to be expressed.

With respect to a kind of functions, a scene is composed of one top node, a child node in tree shape allocated in a lower layer of the top node and a grandchild node in a lower layer of the child node.

A “Layer 2D” node, which represents a scene as a two dimensional scene, is provided and a “Common_Group” node representing a background picture and an audio for displaying a common background picture and a common BGM, a “Switch” node representing exclusively for an adult and another “Switch” node for a child can be formed in the lower layer of the “Layer 2D” node.

Further, a “Group” node representing an object suitable for being observed by a child and a “TouchSensor” node are described under the other “Switch” node for a child. The “TouchSensor” node outputs an event in response to a mouse button being clicked by a user.

The output of event is inputted to the “Switch” node, so that an object is switched over from an object for an adult to that for a child or vice versa cyclically in response to each clicking of the mouse button.

Such a node activated in response to a time and an action by a user is referred to as a sensor system node. It is possible to make a scene possess interactivity by using those sensor system nodes.

In the MPEG-4 System, a scene is constituted by combining a scene description node and an object, and it is possible to operate interactively by using an event.

Accordingly, by using one description by the BIFS and by adding a reproduction protection information signal produced for permitting a reproduction in accordance with a region code or a rating code, a reproduction control for each object can be realized.

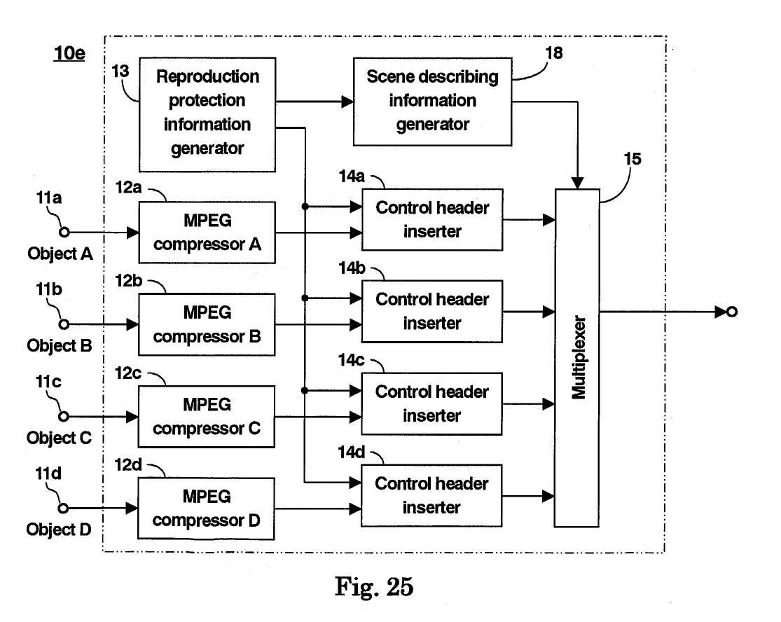

FIG. 25 is a block diagram of a third apparatus for encoding object data by using a constitutional data of scene description.

In FIG. 25, a third apparatus 10e for encoding object data (hereinafter referred to as third encoding apparatus 10e) is identical to the first encoding apparatus 10a shown in FIG. 4 except for a scene describing information generator 18. A information signal related to a region code and a rating code generated by the reproduction protection information generator 13 is supplied to the scene describing information generator 18 as well as to each of the control header inserters 14a through 14d. A scene description information generated by the scene description information generator 18 is supplied to the multiplexer 15.

In the scene describing information generator 18, a reproduction protection information such as a region code and a rating code for a predetermined group of objects is described by the structure of scene description mentioned above. An ID information specifying uniquely that a scene describing information added with the reproduction protection information designates which group of objects is affixed to a control header of the reproduction protection information described.

Such a scene describing information added with a reproduction protection information is supplied to the multiplexer 15 and multiplexed therein, and finally supplied to the recording medium as a compressed data together with each compression-encoded object data.

Reproducing a compressed data recorded in a recording medium by the method mentioned above is explained next.

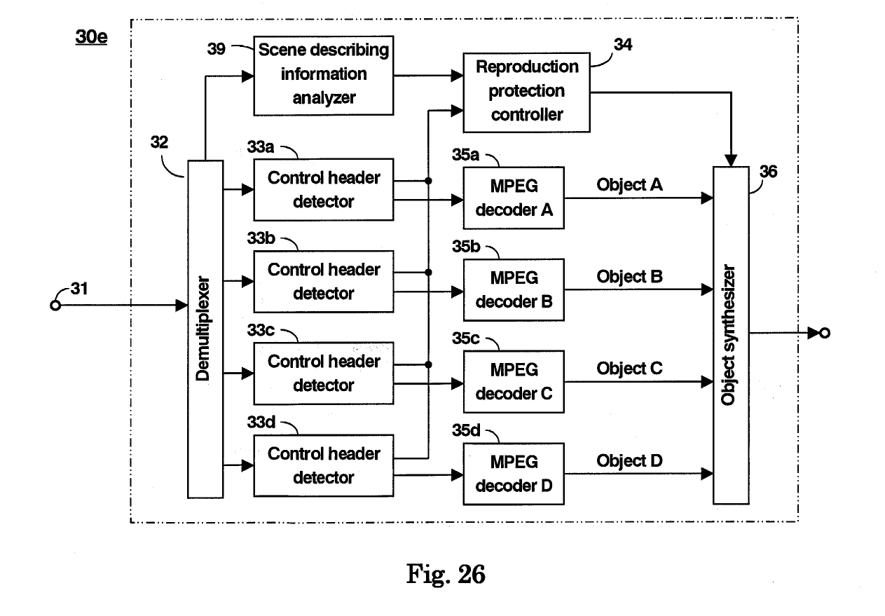

FIG. 26 is a block diagram of a third apparatus of decoding object data. In FIG. 26, a third apparatus 30e of decoding object data (hereinafter referred to as third decoding apparatus 30e) is identical to the first decoding apparatus 30a shown in FIG. 5 except for a scene describing information analyzer 39. The scene describing information analyzer 39 is installed between the demultiplexer 32 and the reproduction protection controller 34.

A compressed data reproduced from a recording medium (not shown) is demultiplexed by the demultiplexer 32 and released from a multiplexed signal. A compression-encoded signal obtained by demultiplexing is supplied to the control header detectors 33a through 33d, and at the same time, a released scene describing information is supplied to the scene describing information analyzer 39.

In the scene describing information analyzer 39, a group of objects enabled to display for a scene is designated and a reproduction protection information such as a region code and a rating code corresponding to the group of objects is analyzed that it is what kind of reproduction protection information. An information in accordance with the result of analysis is supplied to the reproduction protection information controller 34.

In the reproduction protection information controller 34, object data are controlled to be synthesized in accordance with a reproduction protection signal for the specified group of objects. In this case, a group of objects is designated and specified by an ID information, which specifies uniquely that a scene describing information added with the reproduction protection information designates which group of objects is affixed to a control header of the reproduction protection information.

The reproduction protection information for each group of objects generated by the scene describing information generator 18, which is built in the third encoding apparatus 10e is multiplexed together with compression-encoded object data, and then recorded in a recording medium. A scene describing information of the recorded compressed data is analyzed by the third decoding apparatus 30e, and a synthesized object signal, which is conducted by a reproduction protection control for each group of objects, is obtained. The obtained synthesized object signal is displayed by a monitor TV or like.

Transmitting and receiving a compression-encoded object data, which is conducted by a reproduction control for each group of object and transmitted, are depicted next.

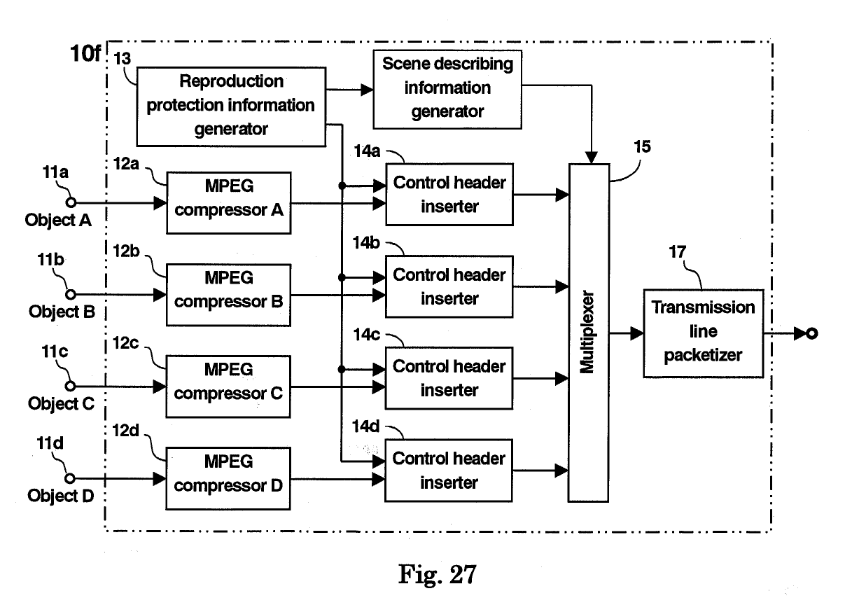

FIG. 27 is a block diagram of a second transmitting apparatus of object data by using a structure of scene description. In FIG. 27, a second transmitting apparatus 10f of object data is identical to the third encoding apparatus 10e shown in FIG. 25 except for a transmission line packetizer 17. A compressed data from the multiplexer 15 is supplied to the transmission line packetizer 17. In the transmission line packetizer 17, the multiplexed compressed data is packetized and transmitted to a transmission line.

Such a packetized compression-encoded signal as mentioned above is supplied to a transmission line or network such as the Internet. The packetized compression-encoded signal is received by a receiving apparatus of encoded object data being connected to the network.

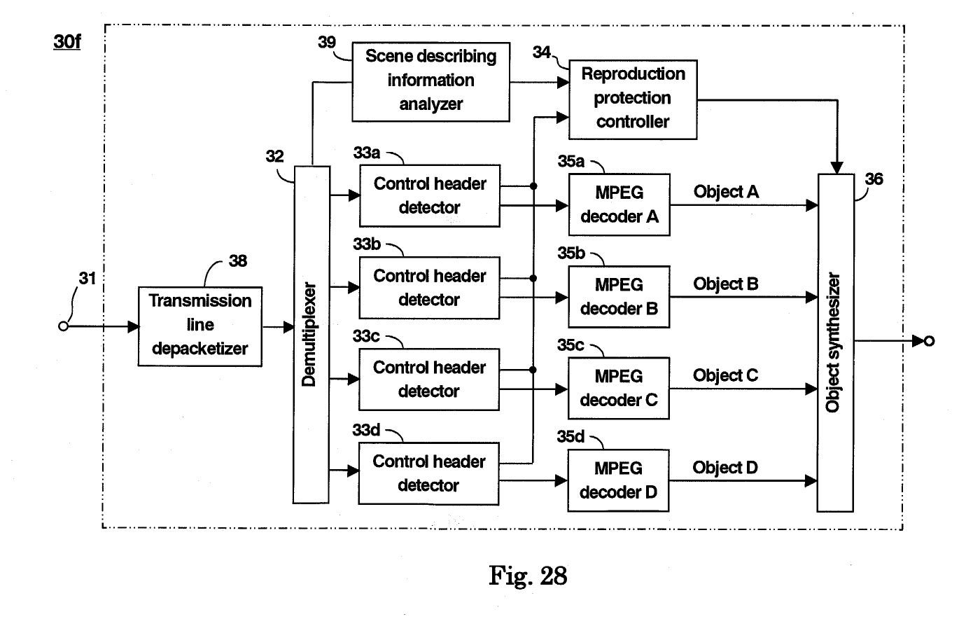

FIG. 28 is a block diagram of a third receiving apparatus of object data, which receives a signal by detecting a control header attached to a packetized compression-encoded signal. In FIG. 28, a third receiving apparatus 30f of object data is identical to the third decoding apparatus 30e shown in FIG. 26 except for a transmission line depacketizer 38. A compressed data processed by the transmission line depacketizer 38 is supplied to the demultiplexer 32.

A signal transmitted through a transmission line is released from packetization by the transmission line depacketizer 38 and resulted in a compressed data of compression-encoded signal. The compressed data obtained as a signal composed of only a payload is supplied to the demultiplexer 32 and processed through the same operations as the third decoding apparatus 30e. Then, a synthesized signal containing a desired group of objects is produced. The produced synthesized signal is supplied to a monitor TV (not shown) and displayed thereon.

Programs for encoding a signal and transmitting the encoded signal are explained next. The programs are used for producing a compression-encoded object signal, which is recorded or transmitted after reproduction of each group of objects is controlled, by executing a computer.

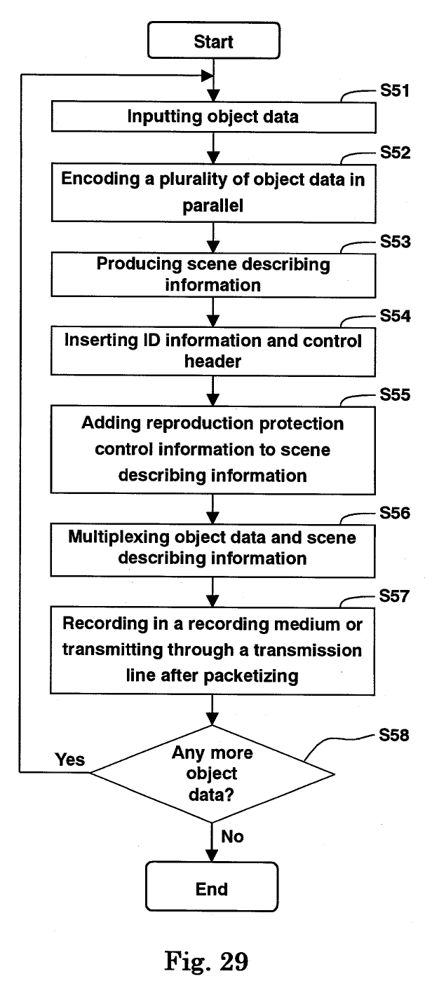

FIG. 29 is a fifth flow chart showing a program of encoding process of object data, which performs reproduction control for a predetermined group of objects, by inserting a control header into the object data. In FIG. 29, each execution program is exhibited by each step of encoding processes.

In FIG. 29, an object data of picture is supplied to an MPEG compressor as an input signal (step: S51). The supplied object data is compression-encoded in parallel, and a plurality of compression-encoded object data corresponding to each object is produced (step: S52).

A scene describing information is produced (step: S53). The scene describing information, which is described in a control header, and an ID signal for specifying uniquely an object are inserted into the plurality of compression-encoded object data (step: S54).

A reproduction protection control signal is added to the scene describing information (step: S55). A multiplexed data is produced by multiplexing the plurality of compression-encoded object data and the produced scene describing information (step: S56).

The multiplexed data produced as mentioned above is recorded in a recording medium, or packetized in accordance with a signal format in order to supply to a predetermined transmission line, and then the packetized compression data is supplied to the predetermined transmission line (step: S57).

The steps S51 through S57 are continuously repeated until it is detected that no more object data inputted is remained (step: S58). The total process comes to end when all the object data are recorded or transmitted.

By using a structural data of scene description in order to reproduce object data recorded or transmitted as mentioned above, programs for decoding an encoded signal and for receiving such a decoded signal is explained next.

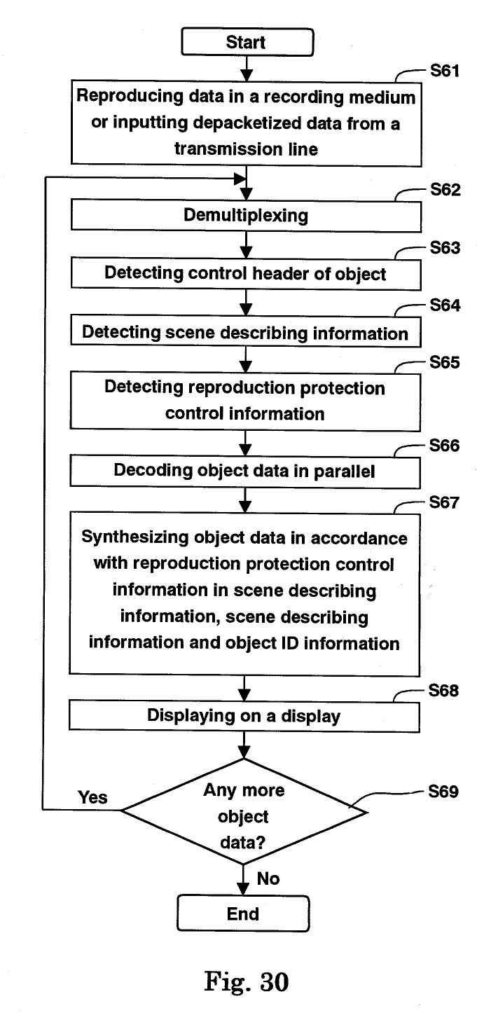

FIG. 30 is a sixth flow chart showing a program of decoding process of object data in order to reproduce object data containing a group of objects, which is recorded or transmitted with being affixed with a control header.

In FIG. 30, an object data recorded in a recording medium is reproduced as a compressed data, or an object data composed of only a payload, which is supplied to a transmission line depacketizer as a packetized object data and released from packetization therein, is obtained as a compressed data (step: S61).

The compressed data is supplied to a demultiplexer and each of object data multiplexed is separated (step: S62). A control header of each object data is detected (step: S63).

A scene describing information is detected in the detected control header (step: S64). A reproduction protection information is detected in the detected scene describing information (step: S65). The compression-encoded object data is decoded in parallel and resulted in each object data signal (step: S66).

Each of the decoded object data signals and a signal of a group of objects are synthesized in accordance with a reproduction protection information in a scene describing information, the scene describing information and an ID information attached to each object (step: S67). A video signal obtained by synthesizing object data signals is displayed on a displaying device (step: S68).

It is detected whether any more inputted object data is existed or not (step: S69). The steps S62 through S68 are repeated until no more inputted data remains. The process comes to end when no inputted object data is existed.

In the encoding and decoding methods mentioned above, a protection information for reproducing a medium recorded with an encoded signal is recorded together with an object signal. When reproducing the recorded object signal, by designating a predetermined protection information and by combining both of recording and reproducing systems, it is essential that a reproduction protection level of object to be reproduced is determined and a reproduction control method for displaying is realized.

Details of such a reproduction control method is disclosed in the Japanese Patent Laid-open Publication No. 7-23131/1995 entitled “Reproduction Protection Method and Protection Reproducing Apparatus”, which was invented by the inventor of the present invention and filed by the same applicant as the present invention.

Both of a media protection data and a main data such as an audio data and video data to be recorded in a medium are recorded in accordance with a recording method suitable for respective recording medium. In a case of an optical disc, both the media protection data and main data are recorded by a recording method of forming a pit. In a case of a magnetic recording medium such as a magnetic disc, a magnetic tape and a photo-magnetic disc, both the media protection data and main data are recorded by a recording method of magnetizing a magnetic medium. Further, in a case of being recorded in a configuration of enabling to be incidental to each object data physically, a recording medium, which can conduct reproduction control, can be realized even though it is recorded by any recording methods.

A protection information recorded in a recording medium can be attached with a time information or time period information, which validates a protection control information. In this case, an object, which is conducted by reproduction control, can be displayed by a decoding apparatus or receiving apparatus in which a time information is managed.

The reproduction control can specify that a scene describing information, for example, specifies an object existing in a scene together with a time axis information. Therefore, it is acceptable that a time period information validating a protection control information is described by using the scene describing information.

It is also acceptable that a protection information recorded in a recording medium is composed of at least a parental lock function, which restricts reproduction of some scenes such as violence and sexuality. In this case, a method of restricting reproduction based on the rating system for movies in the U.S.A. can be applied.

Furthermore, it is acceptable that a user can alter a protection information assigned to a reproducing apparatus for increasing a degree of protection, in other words, decreasing a degree of violence or sexuality exposed in a movie.

As mentioned above, contents recorded in a medium or transmitted through a network are conducted by individual reproduction control for displaying and sounding each specific object such as a specific person or specific background in a reproduced picture and a voice pronounced by a specific person or BGM in an audio signal. Further, those objects or group of objects are synthesized by switching over among them. Furthermore, a reproduction control signal recorded in accordance with each object can be recorded, transmitted and reproduced by embedding the reproduction control signal in an electronic watermark or a content information encoded by a scene describing information. Therefore, the contents can be protected from alteration or illegal reproduction. Accordingly, an encoding method, a producing method and a decoding method of an object data, which is hard to be altered due to a higher security level, and an encoding apparatus, a producing apparatus and a decoding apparatus for such an object data, programs for encoding and decoding the object data and a recording medium for the object data can be realized.

According to a first aspect of the present invention, there provided an encoding method of object data. A content signal can be produced by synthesizing object data, which are permitted to reproduce in accordance with a reproduction protection information signal out of a plurality of object data constituting contents. Therefore, the contents are protected from reproduction in accordance with a code information such as locality and restriction by age. Accordingly, the object data encoded by the encoding method are high in security level and hard to be reproduced illegally by alteration.

According to a second aspect of the present invention, there provided another encoding method of object data. Particularly, a reproduction protection information signal is produced by encrypting a reproduction protection information by an electronic watermark, so that the object data encoded by the other encoding method are higher in security level and harder to be reproduced illegally by alteration than that of the encoding method mentioned above in addition to the effects therein.

According to a third aspect of the present invention, there provided a producing method of object data. The object data are packetized and multiplexed. Therefore, the object data produced by the producing method are high in security level and hard to be reproduced illegally by alteration.

According to a fourth aspect of the present invention, there provided a decoding method of object data so as to reproduce encoded object data, which are high in security level and hard to be reproduced illegally by alteration.

According to a fifth aspect of the present invention, there provided an apparatus for encoding object data. A content signal can be produced by synthesizing object data, which are permitted to reproduce in accordance with a reproduction protection information signal out of a plurality of object data constituting contents. Therefore., the contents are protected from reproduction in accordance with a code information such as locality and restriction by age. Accordingly, the object data encoded by the apparatus are high in security level and hard to be reproduced illegally by alteration.

According to a sixth aspect of the present invention, there provided an apparatus for producing object data, which are high in security level and hard to be reproduced illegally by alteration.

According to a seventh aspect of the present invention, there provided an apparatus for decoding object data so as to reproduce encoded object data, which are high in security level and hard to be reproduced illegally by alteration.

According to an eighth aspect of the present invention, there provided a program for encoding object data by executing a computer for encoding object data, which are high in security level and hard to be reproduced illegally by alteration.

According to a ninth aspect of the present invention, there provided a program for decoding object data by executing a computer for decoding encoded object data, which are high in security level and hard to be reproduced illegally by alteration.

According to a tenth aspect of the present invention, there provided a recording medium recorded with a multiplexed signal, which is obtained by multiplexing a reproduction protection information signal for permitting reproduction of a plurality of object data constituting contents and a compression-encoded signal of each of the plurality of object data, wherein the object data are high in security level and hard to be reproduced illegally by alteration.

What is claimed is:

1. An encoding method of object data comprising steps of:
producing a reproduction protection information signal so as to permit reproduction of a plurality of object data constituting contents;
compression-encoding each of the plurality of object data and resulted in a compression-encoded signal of each object; and
multiplexing the reproduction protection information signal and the compression-encoded signal and producing a multiplexed signal.

2. The encoding method of object data in accordance with claim 1, wherein the reproduction protection information signal is produced by an electronic watermarking method.

3. A producing method of object data comprising steps of:
producing a reproduction protection information signal so as to permit reproduction of a plurality of object data constituting contents;
compression-encoding each of the plurality of object data and resulted in a compression-encoded signal of each object;
multiplexing the reproduction protection information signal and the compression-encoded signal and producing a multiplexed signal thereby; and
producing a packetized multiplexed signal by packetizing the multiplexed signal produced in the step of multiplexing by every predetermined amount of data.

4. A decoding method of object data for decoding a multiplexed signal produced by multiplexing a reproduction protection information signal for permitting reproduction of a plurality of object data constituting contents and a compression-encoded signal of each object obtained by compression-encoding each of the plurality of object data, the decoding method comprising steps of:
separating the multiplexed signal into the compression-encoded signal and the reproduction protection information signal; and
synthesizing the plurality of object data permitted to reproduce by the reproduction protection information signal and obtaining a synthesized object signal thereby, wherein the plurality of object data is obtained by decoding the compression-encoded signal.

5. An apparatus for encoding object data comprising:
compression-encoding means for compression-encoding each of a plurality of object data constituting contents and for obtaining a compression-encoded signal of each object thereby;
reproduction protection information signal producing means for producing a reproduction protection information signal so as to permit reproduction of the plurality of object data; and
multiplexed signal producing means for multiplexing the reproduction protection information signal produced by the reproduction protection information signal producing means and the compression-encoded signal obtained by the compression-encoding means and for obtaining a multiplexed signal thereby.

6. An apparatus for producing object data comprising:
reproduction protection information signal producing means for producing a reproduction protection information signal so as to permit reproduction of a plurality of object data constituting contents;
multiplexed signal producing means for multiplexing the reproduction protection information signal produced by the reproduction protection information signal producing means and a compression-encoded signal obtained by compression-encoding each of the plurality of object data and for obtaining a multiplexed signal thereby; and
packetized data producing means for packetizing the multiplexed signal by every predetermined amount of data and for producing a packetized multiplexed signal thereby.

7. An apparatus for decoding object data, wherein the apparatus decodes a multiplexed signal produced by multiplexing a reproduction protection information signal for permitting reproduction of a plurality of object data constituting contents and each compression-encoded signal of each object obtained by compression-encoding each of the plurality of object data, the apparatus comprising:
signal separating means for separating the multiplexed signal into the compression-encoded signal and the reproduction protection information signal; and
signal synthesizing means for synthesizing the plurality of object data permitted to reproduce by the reproduction protection information signal and for obtaining a synthesized object signal thereby, wherein the plurality of object data is obtained by decoding the compression-encoded signal.

8. A program for encoding object data by executing a computer comprising steps of:
producing a reproduction protection information signal for permitting reproduction of a plurality of object data constituting contents in accordance with a region information and a rating information; and
producing a multiplexed signal by multiplexing each compression-encoded signal of each object obtained by compression-encoding each of the plurality of object data.

9. A program for decoding object data, wherein the program decodes a multiplexed signal produced by multiplexing a reproduction protection information signal related to a region information and a rating information so as to permit reproduction of a plurality of object data constituting contents and each compression-encoded signal of each object obtained by compression-encoding each of the plurality of object data by executing a computer, the program comprising steps of:
separating the multiplexed signal into the compression-encoded signal and the reproduction protection information signal; and
synthesizing the plurality of object data permitted to reproduce by the reproduction protection information signal and obtaining a synthesized object signal thereby, wherein the plurality of object data is obtained by decoding the compression-encoded signal.

10. A recording medium for object data characterized in that the recording medium is recorded with a multiplexed signal obtained by multiplexing:
a reproduction protection information signal produced so as to permit reproduction of a plurality of object data constituting contents in accordance with a region information and a rating information; and
a compression-encoded signal of each object obtained by compression-encoding each of the plurality of object data.
